(19) United States
(12) Patent Application Publication
(10) Pub. No.: US 2005/0162402 A1
(43) Pub. Date: Jul. 28, 2005

(54) Methods of interacting with a computer using a finger(s) touch sensing input device with visual feedback

(76) Inventor: Susornpol Joe Watanachote, Bangkok (TH)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/766,143

(22) Filed: Jan. 27, 2004

(51) Int. Cl. G09G 5/00

(52) U.S. Cl. 345/173

(57) ABSTRACT

A data input device includes a finger touch sensing surface wherein the finger touch sensing surface is configured to produce a visual feedback in response to a touching of the touch inputs, the visual feedback indicating an absolute location that the finger touch sensing surface was touched by a finger.

### FIELD

The present system and method relate to computerized systems. More particularly, the present system and method relate to human computer interaction using finger touch sensing input devices in conjunction with computerized systems having visual feedback.

### BACKGROUND

Computerized systems such as computers, personal data assistants (PDA) and mobile phones, receive input signals from a number of input devices including a stylus, a number of touch sensors, mice, or other switches. However, traditional input devices pale in comparison to hands and fingers capabilities. Work and tasks are performed every day using our hands and fingers. It is the dexterity of our hands that creates the world today. While computer technology has advanced at an incredibly high speed for the last two decades, computer technology is rarely used for tasks that require high degrees of freedom such as classroom note-taking situations. Computerized systems are limited by the current input hardware and its human computer interaction methods.

For example, switches are typically found in the buttons of mice, joysticks, game pads, mobile phone keypads, and the keys of keyboards. As computerized systems get smaller, user input through these input devices is not always feasible. Mechanical keyboards have limited features due the size and shape of their buttons. Moreover, PDA devices and mobile phones encounter numerous challenges fitting keyboards onto their systems. As a result, many of these input devices include alternative interfaces such as voice activation, handwriting recognition, pre-programmed texts, stylus pens, and number keypads. Accordingly, it may be difficult for an operator to use a word processor to make simple notes on the increasingly small devices.

Additionally, traditional input devices suffer from a lack of flexibility and adaptability. For example, keyboards often have different layouts or are meant to be used for multiple languages. As a result, the labels on these keyboards can be very confusing. Moreover, some computer applications do not use a keyboard as an input device, rather, many computer applications use a mouse or other input device more than a keyboard.

Mouse pointing precision by an operator is also unpredictable and imprecise. Even with new technology, such as the optical mouse, an operator is still unable to use a mouse to freehand a picture. The lack of precision exhibited by a mouse can be partially attributed to the configuration in which an operator handles the mouse. The hand configuration is not the way the human hand is designed to make precise movements. Rather, movements made by a finger are much more precise than movements that can be made by an entire hand.

Mouse operation as an input device also results in unnecessary movements between one location and another. In current operating systems, a pointer pre-exists on the computer screen. This pre-existence reduces direct operation because the cursor must be moved to a desired target before selecting or otherwise manipulating the target. For instance, an operator must move a pointer from a random location to a ‘yes’ button to submit a ‘yes’ response. This movement is indirect and does not exploit the dexterity of the human hands and fingers, thereby limiting precise control.

Finger touch-sensing technology, such as touch pads, has been developed to incorporate touch into an input device. However, traditional touch-sensing technology suffers from many of the above-mentioned shortcomings including, unnecessary distance that a pointer has to travel, multiple finger strokes on a sensing surface, etc. Furthermore, multiple simultaneous operations are sometimes required such as the operator being required to hold a switch while performing finger strokes.

Touch screen technology is another technology that attempts to incorporate touch into an input device. While touch screen technology uses a more direct model of human computer interaction than many traditional input methods, touch screen technology also has limited effectiveness as the display device gets smaller. Reduced screen size contributes to an operator's fingers blinding the displayed graphics, making selection and manipulation difficult. The use of a stylus pen may alleviate some of these challenges; however, having to carry a stylus can often be cumbersome. Additionally, if the displayed graphics of a computer application are rapid, it may be difficult to operate a touch screen since hands and fingers often blind the operator's visibility. Furthermore, an operator may not wish to operate a computer near the display devices.

U.S. Pat. No. 6,559,830 to Hinckley et al. (2003), which reference is incorporated hereby in its entirety, discloses the inclusion of integrated touch sensors on input devices, such that these devices can generate messages when they have been touched without indicating what location on the touch sensor has been touched. These devices help the computer obtain extra information regarding when the devices are touched and when they are released. However, because the position of the touch is not presented to the computer, touch sensors lack some advantages provided by a touch pad.

Several prior arts allow the operator to communicate with the computer by using gestures or using fingertip cords on a multi-touch surface. However, these methods require the operator to learn new hand gestures without significantly improving the interaction.

### SUMMARY

With a preferred finger(s) touch sensing input device, the present system and method of interacting with a computer can be used properly, creatively and pleasantly. These methods include: active space interaction mode, word processing using active space interaction mode on a small computing device, touch-type on a multi-touch sensing surface, multiple pointers interaction mode, mini hands interaction mode, chameleon cursor interaction mode, tablet cursor interaction mode, and beyond.

### DRAWINGS

The accompanying drawings illustrate various exemplary embodiments of the present system and method and are a part of the specification. The illustrated embodiments are merely examples of the present system and method and do not limit the scope thereof.

FIGS. 1A to 1D show a top view of a position touch-sensing surface according to one exemplary embodiment.

FIG. 2 illustrates a position touch-sensing surface with an air gap feature according to one exemplary embodiment.

FIGS. 3A to 3B illustrate a position touch-sensing surface with a rubber feet feature according to one exemplary embodiment.

FIGS. 4A to 4B illustrate rubber feet layer feature that causes the indentation to be formed in a certain shape according to one exemplary embodiment.

FIG. 5 shows schematic drawing for a touch pad with a virtual switch mechanism according to one exemplary embodiment.

FIGS. 6A to 6D illustrate an active space interaction mode in action according to one exemplary embodiment.

FIG. 7A shows flow chart logic for hand and finger detection in a touch-sensing device according to one exemplary embodiment.

FIG. 7B shows flow chart logic during an active space interaction mode according to one exemplary embodiment.

FIGS. 7C and 7D show flow chart logic during virtual touch-typing mode according to one exemplary embodiment.

FIG. 8 shows word processing with soft keyboard according to one exemplary embodiment.

FIGS. 9A to 9D show examples of various mobile phones with sensing surfaces according to one exemplary embodiment.

FIGS. 10A, 10B, and 10D show example of PDA designs according to one exemplary embodiment.

FIG. 10C shows the display screen from a touch screen PDA according to one exemplary embodiment.

FIG. 11 shows handheld PC with multi-touch sensing surface according to one exemplary embodiment.

FIG. 12 shows laptop PC with special multi-touch sensing surface according to one exemplary embodiment.

FIGS. 13A to 13F show multi-touch sensing devices for desktop PC according to one exemplary embodiment.

FIG. 14 illustrates hands resting for virtual touch-typing mode according to one exemplary embodiment.

FIG. 15 shows reference keys for each finger according to one exemplary embodiment.

FIG. 16 shows zoning concept for typewriter when both hands present according to one exemplary embodiment.

FIG. 17 illustrates that virtual touch-typing mode allows flexibility for operation according to one exemplary embodiment.

FIGS. 18A to 18C illustrate half zone configurations according to exemplary embodiments.

FIG. 19 illustrates finger zoning for associated keys according to one exemplary embodiment

FIGS. 20A to 20D illustrate how key mapping changes according to the finger positions according to one exemplary embodiment.

FIG. 20E shows resting regions label on the sensing surface according to one exemplary embodiment.

FIG. 20F shows an incident when hands were rested outside the resting regions according to one exemplary embodiment.

FIG. 21 illustrates multiple pointers interaction mode in action according to one exemplary embodiment.

FIG. 22 illustrates example of pointer at various pressures according to one exemplary embodiment.

FIG. 23 illustrates mini-hand interaction mode in action according to one exemplary embodiment.

FIGS. 24A to 24D illustrate computer interaction that almost simulates real life according to one exemplary embodiment.

FIGS. 25A to 25D illustrate instances of chameleon cursor interaction mode according to one exemplary embodiment.

FIG. 26 illustrates using of tablet cursor interaction mode on a PDA.

Throughout the drawings, identical reference numbers designate similar, but not necessarily identical, elements.

### DETAILED DESCRIPTION OF ILLUSTRATIVE EMBODIMENTS

The present human computer interaction systems and methods incorporate the advantages of a number of proprietary types of position touch sensing input devices for optimal effects.

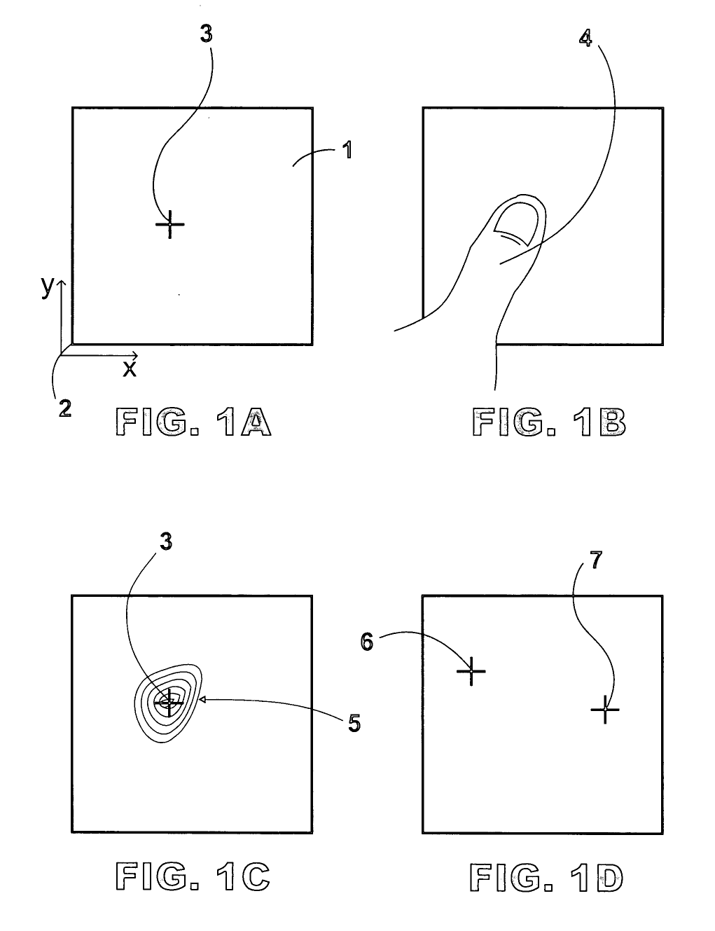

According to one exemplary embodiment, the present system and method provide a position touch-sensing surface, giving a reference for absolute coordinates (X, Y). This surface of the present system may be flat, rough, or have rounded features and can also be produced in any color, shape, or size to accommodate any number of individual computing devices. FIG. 1A illustrates a top view of an exemplary touch-sensing surface (1). According to one exemplary embodiment, the lower left corner of the surface is set as an absolute origin (2), where (X, Y) values equal (0, 0). The coordinate (3) is the position of a detected finger, which has the certain value of (X, Y). FIG. 1B shows a finger (4) on the sensing surface (1), that was detected as coordinate (3) in FIG. 1A. FIG. 1C illustrates the actual contact area (5) of the finger (4). Notice that the coordinate (3) corresponding to the position of the detected finger (4) is a centroid point of the contact area (5).

Additionally, the present system may be able to detect up to one, two, five, or ten individual finger positions depending on its capability. According to one exemplary embodiment, each finger detected will have the reference of the n^{th} index. FIG. 1D illustrates coordinates 6 and 7 when two fingers were detected according to one exemplary embodiment. As shown in FIG. 1D, the two fingers would have (n) values equal to 1 and 2 respectively, and would be referenced as (X, Y)₁ and (X, Y)₂.

Additionally, the messages received by the computerized systems from the present touch-sensing device are the absolute position (a point, or a coordinate) of each sensing finger (X, Y)ₙ relative to its absolute origin, approximated area or pressure value of each sensing finger (Z)ₙ, (Delta X)ₙ—amount of each horizontal finger motion, (Delta Y)ₙ—amount of each vertical finger motion. All this information can be used to calculate additional information such as speed, acceleration, displacement, etc. as needed by a computer.

The system also allows each finger to make a selection or an input by pressing the finger on the sensing surface. This signal is assigned as (S)ₙ—state of virtual button being selected at location (X,Y)ₙ, 0=not pressed, 1=pressed. In fact, (S)ₙ could be derived by setting a threshold number for the (Z)ₙ, if no proprietary mechanism was installed. According to this exemplary embodiment, an input device incorporating the present system and method will provide the sensation of pressing a button such as surface indentation when (S)ₙ=1. This mechanism is also known as a virtual switch or virtual button.

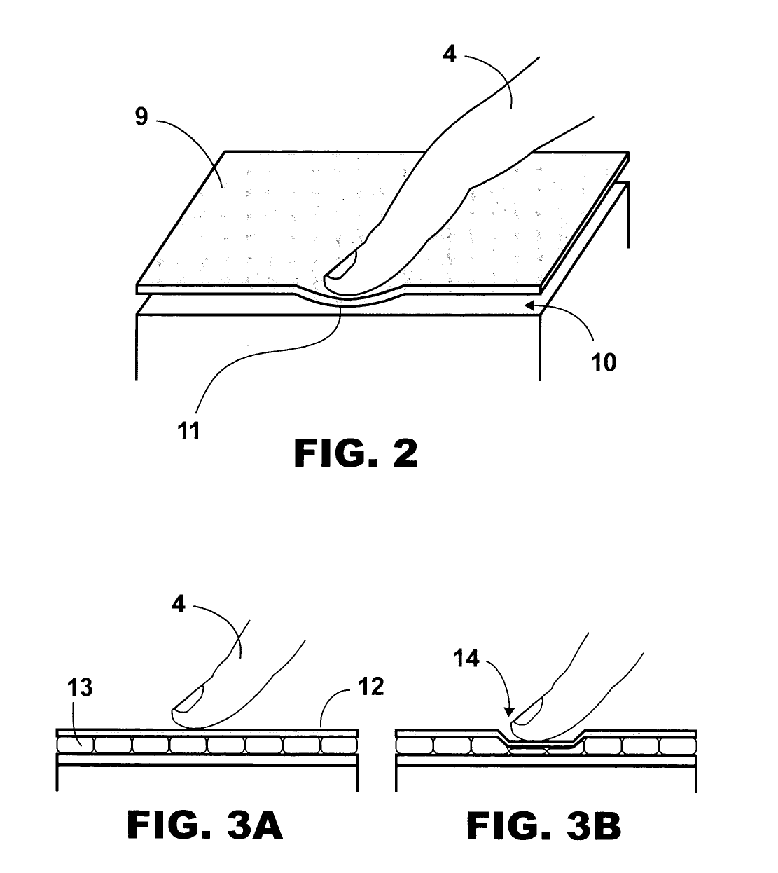

FIG. 2 illustrates an example of a virtual button surface (9) in a perspective view using an air gap or a spacer (10) according to one exemplary embodiment. When a finger (4) presses on the surface (9), an indentation is created around the finger (4), giving the sensation of pressing a switch. The contact point (11) can be calculated by measuring voltage changes between the two layers, though it is not necessary if the device can recognize a (Z)ₙ value.

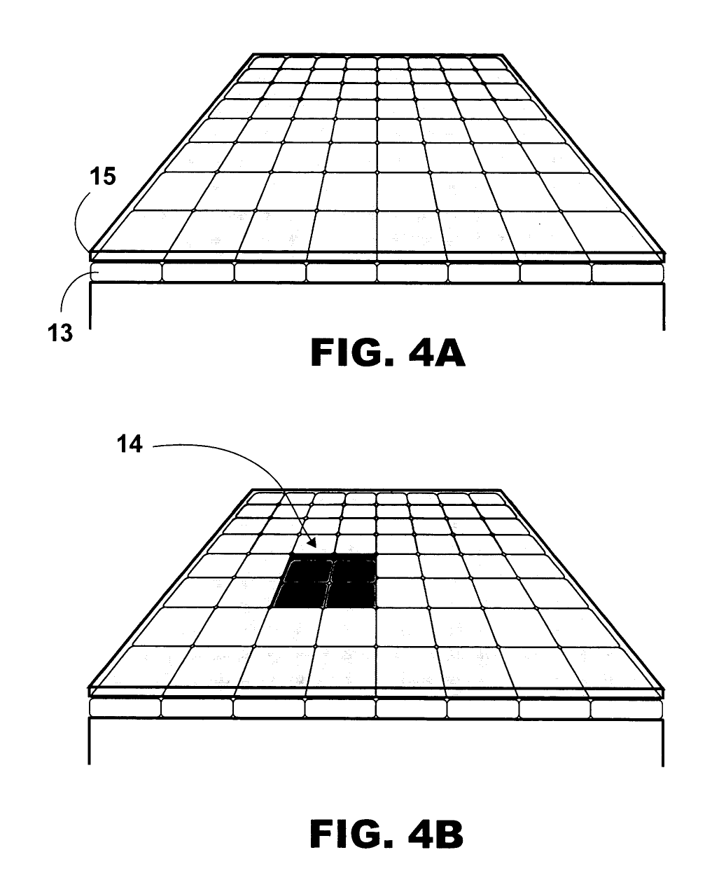

An alternative method that may be used to create the virtual switch feature is illustrated in FIG. 3A by using a rubber feet layer in place of the air gap. According to the exemplary embodiment illustrated in FIG. 3A, the finger (4) is resting on the surface (12). Located beneath the surface (12) is a rubber feet layer (13). FIG. 3B illustrates the pressing of the embodiment illustrated in FIG. 3A. The indentation area (14) caused by the pressing may be a round, square, hexagon, or any other form depending on the layout of the rubber feet (13). FIG. 4A illustrates a perspective view of the touch sensing surface illustrated in FIG. 3A. The top layer (15) of the touch sensing surface is transparent, thereby facilitating a view of the square shape rubber feet layer (13). FIG. 4B shows that if the top layer (15) is pressed with a finger or other object, the indentation on the surface will be a square shape (14) according to the rubber feet feature.

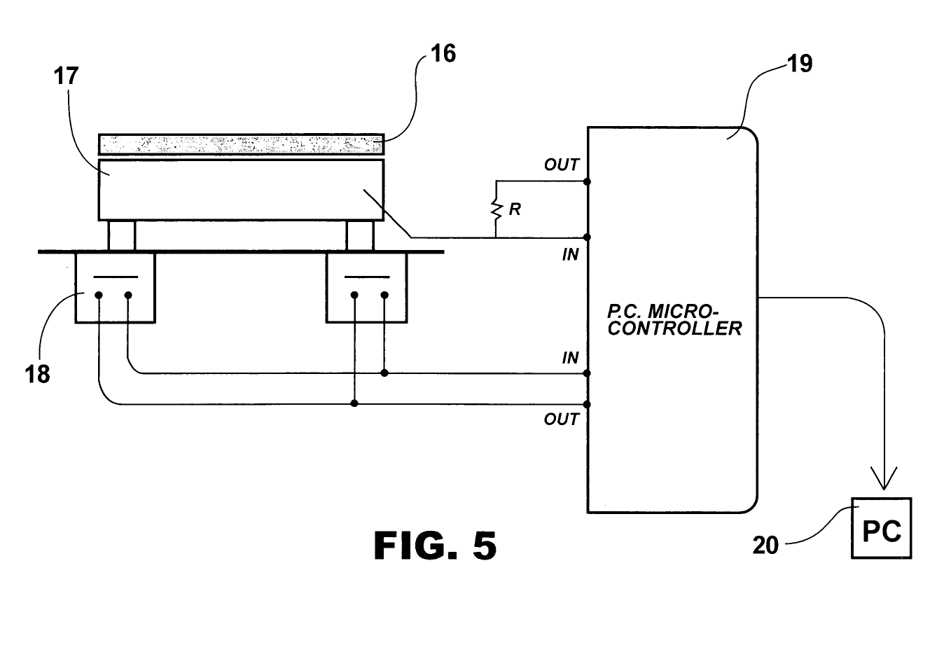

The air gap and rubber feet techniques illustrated above are suitable for a multi-input sensing surface, because they allow each individual finger to make an input decision simultaneously. However, for a single-input sensing device having a hard surface, such as a touch pad for instance, there is no need to worry about input confusion. A virtual switch mechanism can be added to a touch pad by installing a physical switch underneath. FIG. 5 illustrates one exemplary embodiment of a touch pad having a virtual switch mechanism. As shown in FIG. 5, four switches (18), connected electrically in parallel, are located below each corner of a touch pad. According to the schematic drawing illustrated in FIG. 5, the insulator surface (16) of the touch pad configured to protect a user's finger from the analog grid layer (17) can detect a finger position. Additionally, four switches (18) are coupled in parallel behind four corners of the touch pad. All electrical signals sensed by the analog grid layer (17) will be sent to a micro-controller (19) to interpret raw signals and send signal interpretations and commands to a communicatively coupled computerized system (20).

According to one exemplary embodiment, the present system and method is configured to detect both an operator's left and right hand positions along with their individual fingertip positions. This exemplary system and method designates the individual hand and fingertip positions by including an extra indicator in the finger identifiers—(R) for right hand and (L) for left hand, ie. (X, Y)_{nR}. The convention setting can be (R=1) for fingers corresponding to the right hand, and (R=0) for the left hand. By detecting both an operator's left and right hand positions as well as associated finger positions and hovering hands above the sensing surface, additional information may be gathered that will help in better rejecting inputs caused by palm detections.

According to one exemplary embodiment, input devices may be prepared, as indicated above, to detect a single finger or multiple fingers. These input devices may include a customized touchpad or multi-touch sensors. Additionally, multiple element sensors can be installed on any number of input devices as needed for more accurate positioning. Implementation and operation of the present input devices will be further described below.

Active Space Interaction Method

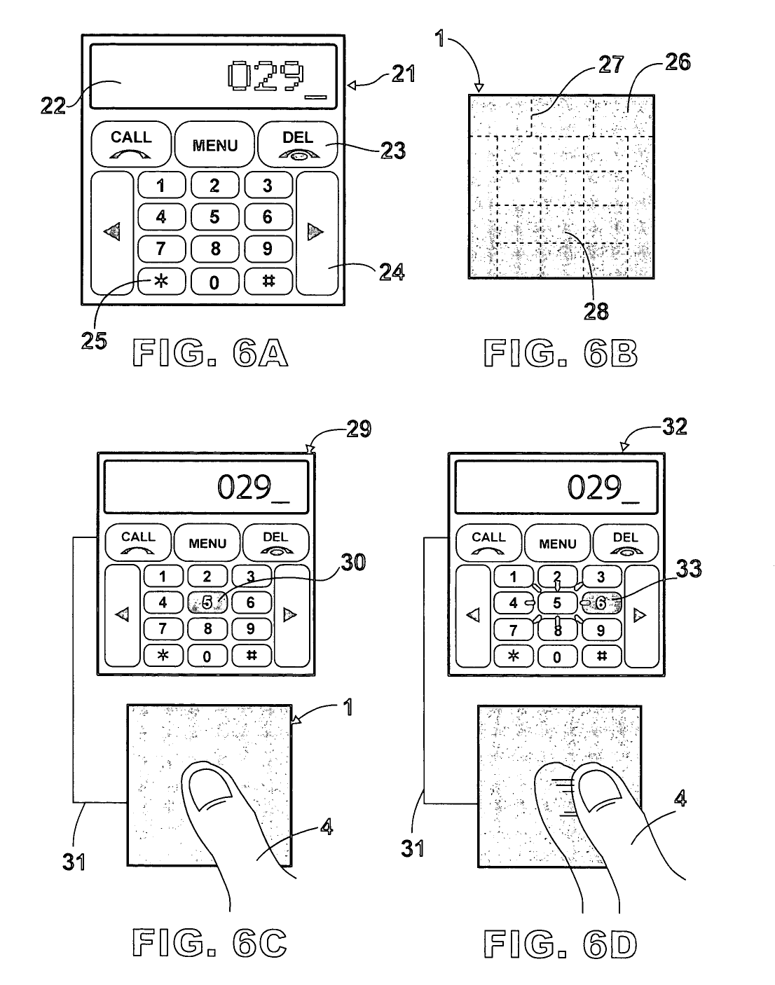

Active space interactive method is a system and a method that allows software to interpret a current active area (e.g. an active window, an active menu) and map all the active buttons or objects in this active area onto an associated sensing surface. According to one exemplary embodiment, once the active buttons have been mapped, the operator will be able to select and/or control the options on the screen as if the screen were presently before them. FIG. 6A illustrates a display screen (21) of a mobile telephone which is considered as an active area according to one exemplary embodiment. The graphic (22) portion of the cell phone is a non-active object, because the operator cannot make any manipulation on it. However, the other graphics (23, 24, and 25), which are buttons ‘DEL’, ‘>’, and ‘*’ respectively, are active graphics. As active graphics, the above-mentioned buttons can be selected by an operator. So that they may be accessed by a user, the active graphics (23, 24, and 25) are mapped on the sensing surface (1) of FIG. 6B. As shown in FIG. 6B, prior to the detection of a finger, the active graphics (23, 24, and 25; FIG. 6A) are mapped to designated areas on the sensing surface (1). The dotted line (27) illustrated in FIG. 6B represents an imaginary line that separates the active graphics. By way of example, the block (26) represents a space designated for the ‘DEL’ button and block (28) represents a numerical ‘8’ button.

FIG. 6C illustrates the operation of the active space system. As shown in FIG. 6C, when a finger (4) is over a particular section of the sensing surface (1), the corresponding active button (30) will be highlighted in the display screen (29). The line (31) illustrated in FIG. 6C indicates that the display screen (29) and the sensing surface (1) work together as a system. Depending on the complexity of the objects on the screen, the mapping may not exactly mirror the display. However, software associated with the mapping function of the present system and method will calculate an optimal mapping according to the size of the sensing area and the complexity of buttons in the active area. In some embodiments, the buttons mapped on the sensing surface can be smaller or larger than the active buttons displayed on the screen.

Once a finger is detected on the sensing surface (1), the button mapping on the sensing surface ceases. With the button mapping eliminated, a user's finger (4) may be slid to the left to activate a browsing function. When activated, the browsing function moves to the active graphic to the immediate left of the previously selected location. Similar browsing functions may be performed by sliding a finger (4) to the right, up, and/or down. To make a selection of an illuminated active graphic, the operator simply presses on the sensing surface.

FIG. 6D illustrates a browsing function. As shown in FIG. 6D, when the operator slides a finger (4) slightly, the display screen (32) responds with a new highlighted active graphic indicating the selection of a new button (33). Note, however, that the new location of the finger (4) does not necessarily correspond with the active button mapping in FIG. 6B that was established for new button selections. Rather, new selections performed during a browsing operation depend on a displacement distance of the finger (4) position. For example, a setting can be three units vertical and two units horizontal. According to one exemplary embodiment, the units used for the above-mentioned displacement recognition may be millimeters. Accordingly, if a sensed finger (4) is determined to have moved three units upward, the display screen (32) would highlight a new active graphic located immediately up from the previously indicated active graphic. Using the exemplary displacement recognition parameters illustrated above, if the size of the sensing surface is ‘3.0 cm.×3.5 cm’, tens of selections may be browsed in a single stroke of the finger (4). However, the unit settings may be changed dynamically with the changes in active objects positions, and will depend on the complexity of active objects displays on the screen. Moreover, the displacement recognition parameters may be varied according to the personal preferences of each user to provide a useful and smooth browsing experience.

However, for exemplary situations where the available active objects are simple, as shown in FIGS. 6A and 6B, or when the active objects include a choice between ‘yes’ and ‘no’ for instance, the buttons mapped during the initial mapping function may remain even after the operator's first touch, since the large space on sensing surface for each button will ensure a pleasant browsing experience. Alternatively, when the sensing surface (1) is very small and active objects are complex, for instance when browsing a soft keyboard, the initially mapped buttons may be removed as illustrated above.

When no fingertip is sensed on the sensing surface (1), there will be no interaction highlighted on the display screen (21). If, however, the finger (4) is sensed on the edge of the sensing surface (1), the distance changes in finger coordinates will be small. In this exemplary situation, the computerized system will use the change in touch area in conjunction with pressure information received from the sensor to aid in the object browsing decisions. Consequently, an operator should never run out of space, as often occurs when browsing for graphical objects using a touch pad as a mouse pointer. Additionally, extra sensors can be added around the edges according to one exemplary embodiment, to increase browsing efficiency.

Since, the image of the active area will not be physically displayed on the sensing surface (1), the user may not locate an intended position at first touch. However, a user will intuitively select a location proximally near the intended position. Accordingly the intended position may be obtained with a minor slide of the finger (4). In contrast, existing systems that use the cursor/pointer system such as a mouse require that the operator first control the cursor/pointer from an arbitrary position on the screen and then move the cursor toward a desired location. Once a desired location is found, the user must then search at that location for a desired button. This traditional method is increasingly more difficult when using a smaller system such as a mobile phone since the display screen is much smaller in size. The present active space interaction system and method facilitates the browsing for graphical objects.

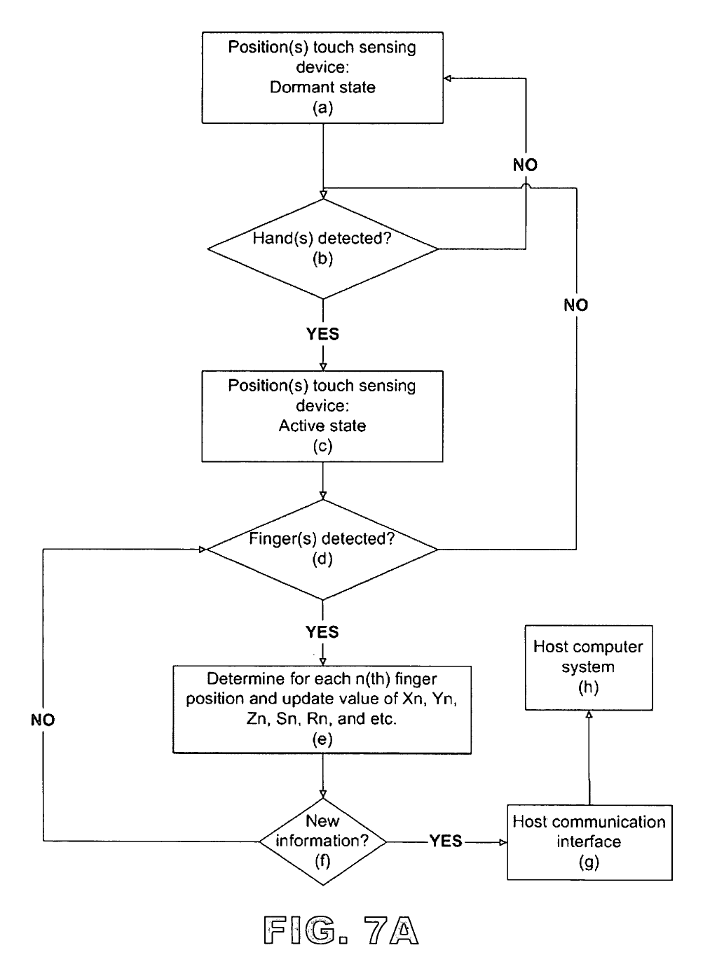

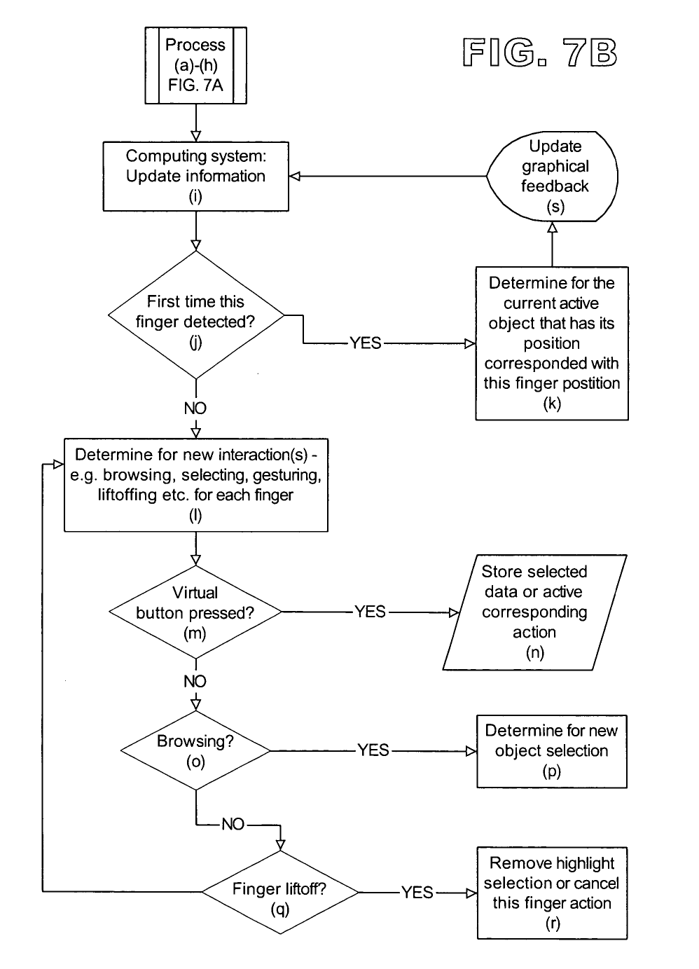

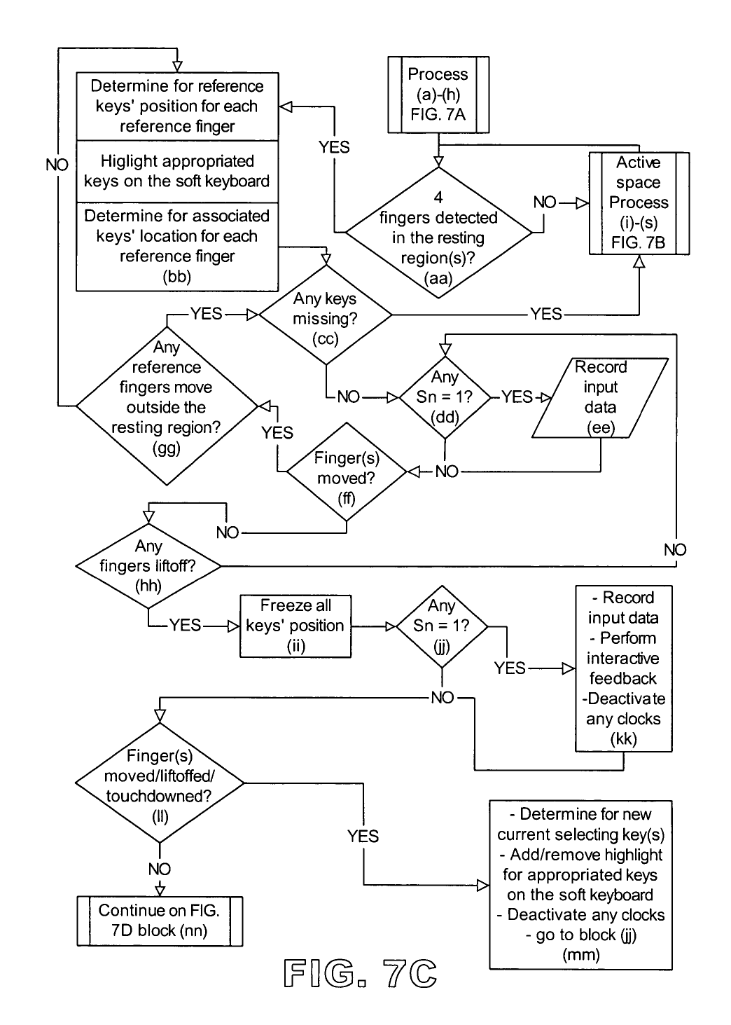

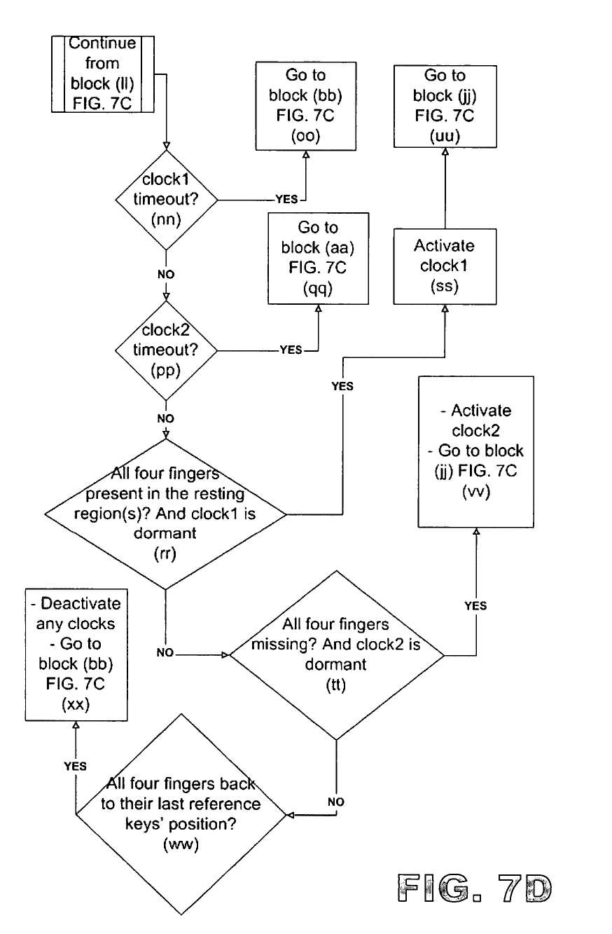

FIGS. 7A and 7B are a flow chart illustrating a general sequential logic for the active space interaction mode functioning in a computerized system. As shown in FIG. 7A, blocks (a) through (f) are common processes that occur in traditional position(s) sensing devices. Note that the input device does not compute the graphical selections in the process covered by blocks (a) through (f). Rather, the input device merely reported finger positions and other messages. All raw data collected from the operations performed in blocks (a) through (f) are sent to a personal computer (PC) in processes (g) and (h). As shown in FIG. 7A, the input device is initially in a dormant state (a). When in this dormant state, the input device is constantly sensing for a hand hovering above the input device (b). If a hand is detected hovering above the input device (b), the input device is placed in an active state (c). When in an active state, the input device checks for the positioning of finger(s) sensed on its surface (d). If a finger is detected, its position and digit values are collected (e) and compared to previously collected positional information (f). If the collected finger information is new (YES, f), the information is passed through the host communication interface (g) and onto the host computer system (h).

FIG. 7B illustrates the above mentioned active space method operating in a computing device. When the computing device receives the information collected in steps (a) through (h), the computing device updates its positional information with the newly collected data (i). It is then determined if the newly collected finger information is detected for the first time (j). If it is determined that the finger is being detected for the first time (YES, j), the computing device will determine the active object that is being selected according to the current active area mapping (k) and update the graphical feedback on the display (s).

Returning again to (j), if the detected finger already has an assigned active object, the computer will search for any new input gestures made (l). New input gestures may include, but are in no way limited to, the pressing of a virtual button (m), browsing (o), and finger liftoff (q). It is the computing device that decides changes in graphical display according to input gesture. If the computing device determines that a virtual button has been pressed (m), the selected data is stored or an action corresponding to the pressing of the virtual button is activated (n). Similarly, if the computing device determines that the newly collected finger information indicates a browsing function, the computing device will determine the new object selected by the browsing operation (p) and update the graphical feedback accordingly (s). If the computing device determines that the newly collected finger information indicates a finger liftoff (q), any highlighted selection or finger action corresponding to that finger will be canceled (r) and the graphical feedback will be updated accordingly (s). In contrast to the present system illustrated in FIG. 7B, traditional systems and methods require the operator to perform repeated gestures such as pressing arrow keys in a conventional mobile phone, or sliding a fingertip once for every new selection in a gesture reading device.

According to one exemplary embodiment of the present system and method, the touch sensing system is configured to detect multiple-finger inputs. Accordingly, multiple highlights will appear on the display screen corresponding to the number of sensed fingers according to the methods illustrated above. Each individual finger detected by the present system has its own set of information recognized by the computing device. Accordingly, the visual feedback provided to the display screen for each finger will be computed individually. Therefore, every time a new finger is detected, the computing device will provide a corresponding visual feedback.

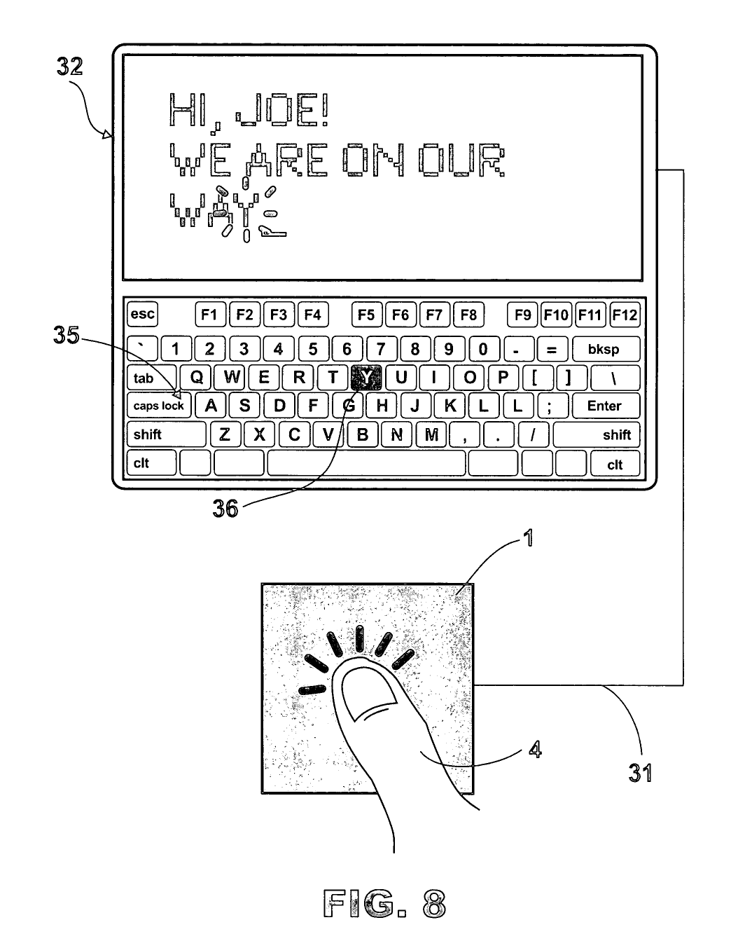

The unique advantage of the active space interaction method illustrated above is in its application to word processing on a mobile phone or other compact electronic device. According to one exemplary embodiment, the present active space interaction method may facilitate word processing on a mobile phone through browsing a display keyboard or soft keyboard. FIG. 8 illustrates word processing with soft keyboard (35) according to one exemplary embodiment. The exemplary embodiment illustrated in FIG. 8 including the display screen (32) is an example of what an operator would see on a mobile phone display. Alternatively, the embodiment illustrated in FIG. 8 may be incorporated into any number of electronic devices including, but in no way limited to, a personal digital assistant (PDA), a pocket PC, a digital watch, a tablet computer, etc. As shown in FIG. 8, the button ‘Y’ (36) is being selected on the soft keyboard (35) by pressing the virtual button according to the methods previously explained. With the multiple finger (4) detecting capability, more advance gestures such as pressing virtual ‘shift’ and letter keys simultaneously is also possible. Finger (4) size would interfere with word processing on tiny spaces using traditional input methods. However, the present system and method eliminate many traditional obstacles associated with traditional input methods. Moreover, the present system and method can be used with any language in the world by simply modifying the soft keyboard and its associated application to the desired language.

Moreover, the present system and method are in no way limited to word processing applications. Rather, the present active space interaction method can also be used for web browsing by operating scrollbars and other traditional browsing items as active objects. According to this exemplary embodiment, an operator can stroke his/her fingers (4) across a sensing surface (1), thereby controllably browsing web content. In fact, browsing may be enhanced by incorporating the present system and method since both the vertical and horizontal scroll control can be done simultaneously. Additionally, simple gestures such as circling, finger stroking, padding, double touching, positioning fingers on various locations in sequence, dragging (by pressing and holding the virtual button), stylus stroking, and the like can be achieved thereby providing a superior human computer interaction method on compact computing devices.

According to one exemplary embodiment, the present system and method may also be incorporated into devices commonly known as thumb keyboards. A thumb keyboard is a small switch keyboard, often used with mobile phone or PDA devices, configured for word processing. Thumb keyboards often suffer from input difficulty due to many of the traditional short comings previously mentioned. If, however, a thumb keyboard is customized with the present system and method, by installing a sensor on each switch or by using a double touch switch (e.g. a camera shutter switch), performance of the thumb keyboards may be enhanced. According to one exemplary embodiment, an operator will be able to see a current thumbs' position on a soft keyboard display.

From the above mentioned explanation, the present active space interaction system and method provide a number of advantages over current input devices and methods. More specifically, the present active space interaction system and method provide intuitive use, do not require additional style learning, are faster to operate than existing systems, and can be operated in the dark if the display unit emits enough light. Moreover, the present systems and methods remove the need to alternately look between the physical buttons and the display screen. Rather, with active space interaction the operator simply has to concentrate on the display screen. Also, since soft keyboards can be produced in any language, restrictions imposed by different languages for layout mapping are no longer a problem when incorporating the present system and method. Consequently, an electronics producer can design a single PDA or phone system which can then be used in any region of the world. Additionally, the present systems and methods reduce the number of physical buttons required on a phone or other electronic device, thereby facilitating the design and upgrade of the electronic device.

In addition to the advantages illustrated above, the present system and method offers higher flexibility for electronic design, allows for an increasingly free and beautiful design, unlocks the capability of portable computing devices by allowing for more powerful software applications that are not restricted by the availability of function buttons. The present active space interaction system can also be connected to a bigger display output to operate more sophisticated software which can be controlled by the same input device. For instance, the present active space interaction system can be connected to a projector screen or vision display glasses; an operation that can not be done with touch screen systems or other traditional input designs. The present system and method can also be implemented with free hand drawing for signing signatures or drawing sketches, can be implemented with any existing stylus pen software, and fully exploits the full extent of all software capabilities that are limited by traditional hardware design, number of buttons, and size. Moreover, the present active space system has an advantage over the traditional stylus pen when display buttons are small. When this occurs, the operator does not need to be highly focused when pointing to a specific location, since the software will aid browsing. As the control and output display are not in the same area, neither operation will interfere with the other, meaning that the finger or pen will not cover the output screen as sometimes occurs on touch screen devices. Thus, the display screen can be produced in any size, creating the possibility of even more compact cell phones, PDAs, or other electronic devices.

Implementation in Various Computing Devices

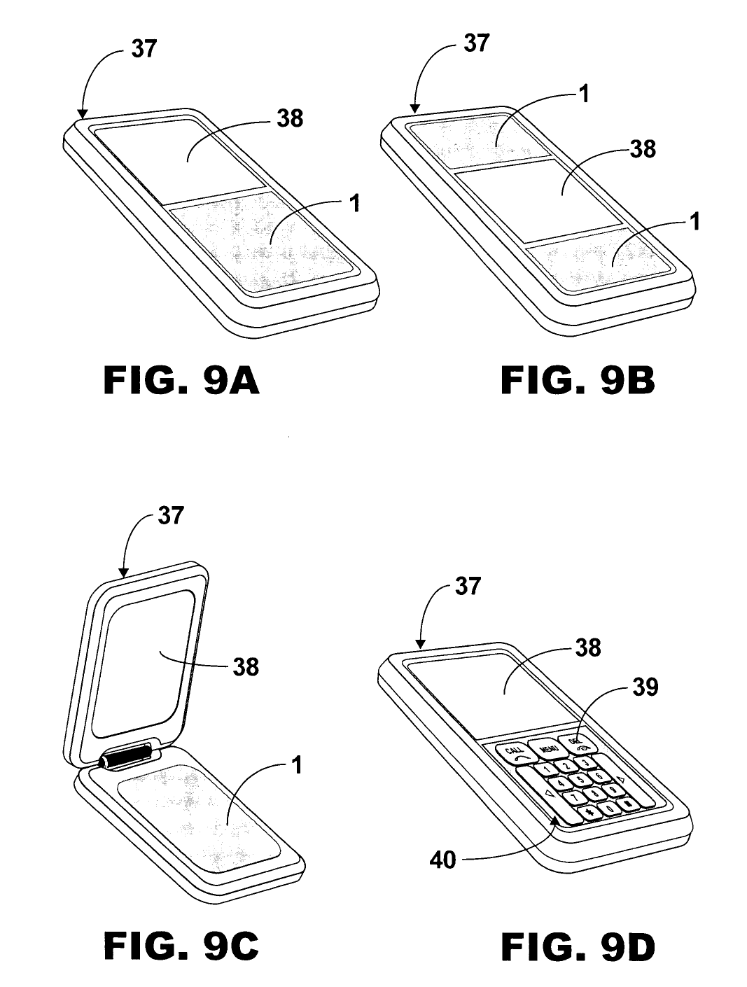

Since mobile phones are usually small in size they have traditionally been limited to a single-input position sensing devices. However, multiple input operations would be preferable and more satisfying to use. FIGS. 9A to 9C illustrate various exemplary mobile phone configurations showing a number of locations where a sensing surface (1) can be installed in relation to a display screen (38) on a mobile phone (37). As shown, the sensing surface (1) may be disposed adjacent the display screen (38) as shown in FIG. 9A, on both sides of the display screen as shown in FIG. 9B, or on opposing portions of a flip phone as shown in FIG. 9C.

In contrast to FIGS. 9A to 9C, FIG. 9D illustrates an exemplary embodiment of a mobile phone having keypad labels (39) on its sensing surface (40). According to this exemplary embodiment, the keypad labels (39) may be designed such that their features are much like a physical switch as in conventional mobile phones. Alternatively, an insulator surface with keypad features can be placed on top of the sensing surface to mock the current mobile phone design. This exemplary mobile phone (37) design will allow a phone to be controlled using keypads and/or a sensing surface.

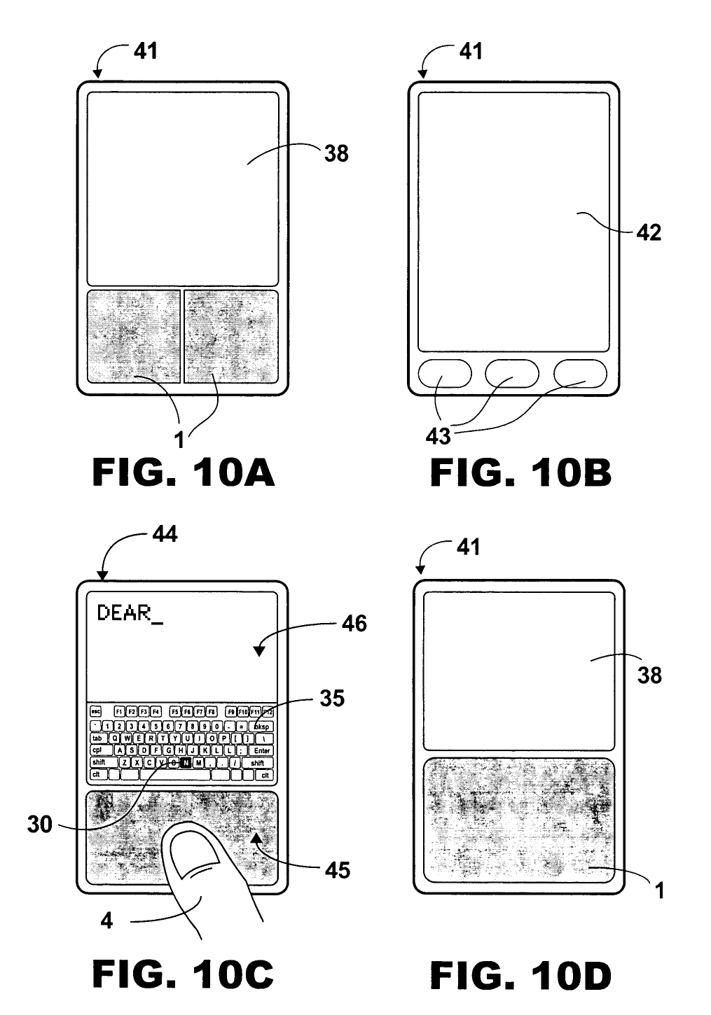

FIGS. 10A, 10B, and 10D illustrate a number of exemplary PDA (41) designs incorporating the present systems and methods. As shown in FIG. 10A, the PDA (41) includes a simple display device (38) and two single-input sensing surfaces (1). Alternatively, FIG. 10D shows a PDA with simple display device (38) and a single multi-input sensing surface (1). While any number of PDA configurations may exist, most PDAs include a single-input touch screen (42) as shown in FIG. 10B. While the present active space interaction system and method may be incorporated into any of the illustrated configurations, FIG. 10C illustrates an exemplary configuration utilizing the present active space interaction method. As shown in FIG. 10C, a touch display screen (44) is simply divided into two zones: one finger touch zone (45) and one active area zone (46). As shown in FIG 10C, a soft keyboard (35) may be displayed on the active area zone (46) indicating the activation of a virtual button (30) by a selective touching of the finger touch zone. Consequently, the virtual button is being highlighted to indicate to a user what button (30) is being activated. While FIGS. 10A-10D illustrate a number of alternative configurations, the position sensing surfaces can be installed any where on the computing devices since the operator only needs to focus on the display when utilizing the present active space interaction method.

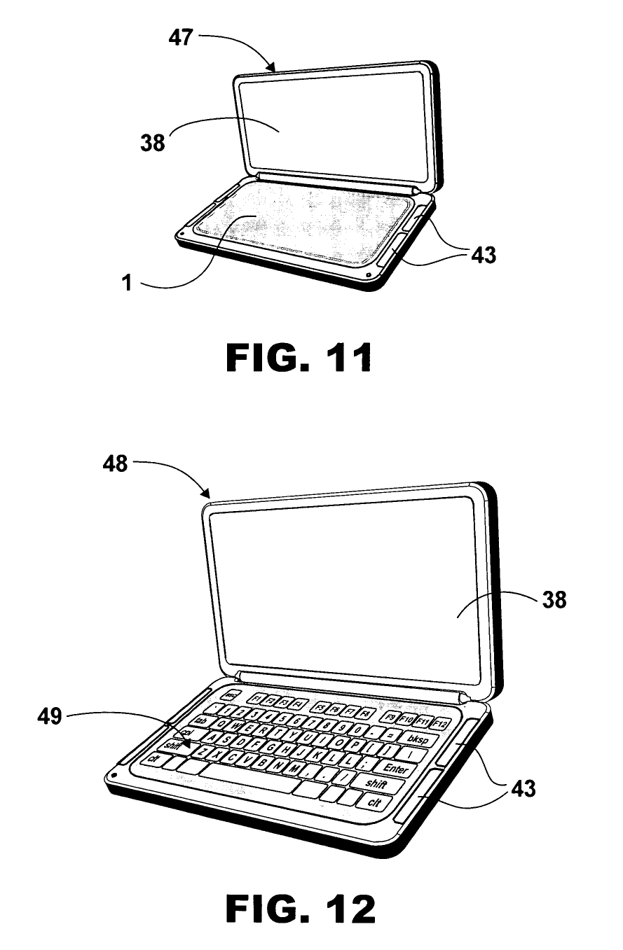

In another exemplary implementation, multi-touch sensing surface capable of sensing more than two positions is suitable for larger computing devices such as laptops or palmtop computing devices. FIG. 11 shows a handheld PC or a palmtop (47) including the present multi-touch sensing surface (1). Additionally, FIG. 12 shows a laptop PC (48) including a specially designed multi-touch surface (49). The surface (49) illustrated in FIG. 12 is designed with various feature surfaces such as smooth, rough, curved, or bumped surfaces to make the surface touch and feel like a conventional keyboard as much as possible. Using the exemplary embodiment illustrated in FIG. 12, an operator can accommodate both new and conventional methods to control a laptop (48).

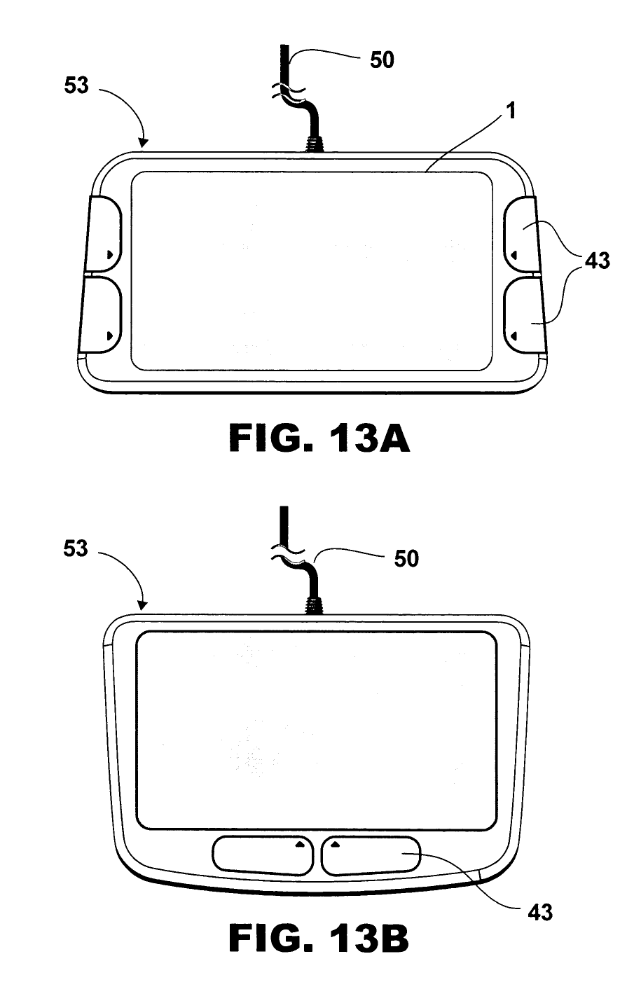

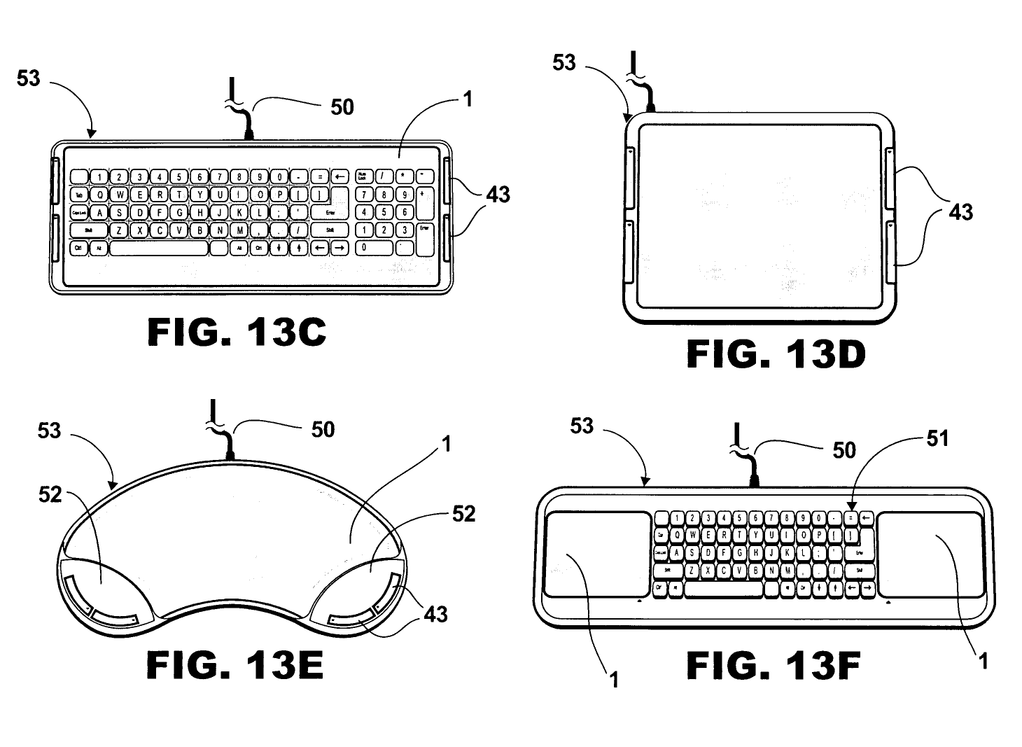

For desktop PCs, the input device incorporating the present active space interaction method can be designed much like conventional keyboards. FIGS. 13A to 13F illustrate several design examples for a multi-touch sensing input device (53) that may be used in conjunction with or in the place of traditional keyboards. The exemplary embodiments illustrated in FIGS. 13A and 13B show multi-touch sensing input devices (53) having different utility switches (43) on various locations. The input devices (53) are communicatively coupled to a desktop PC or other computing device through the cable (50). The exemplary embodiment illustrated in FIG. 13C shows an input device that mocks a conventional keyboard by including a number of labels on the sensing surface (1) that resemble traditional keyboard configurations. In the exemplary embodiment illustrated in FIG. 13D the sensing surface has been enlarged when compared to traditional keyboards. According to one exemplary embodiment, the sensing surface (1) may be enlarged to about the size of a seventeen-inch monitor. The exemplary embodiment illustrated in FIG. 13E shows an ergonomic design shape with hand rest pillows (52). The exemplary embodiment illustrated in FIG. 13F shows a hybrid keyboard including both a conventional keyboard (51) and a plurality of sensing surfaces (1). According to the exemplary embodiment illustrated in FIG. 13F, any number of sensing surfaces (1) may be included with and variably oriented on a conventional keyboard.

As illustrated, some multi-touch sensing devices do not include keyboard labels. Word processing using the active space interaction method alone may not satisfy fast touch-typists. Consequently, the following section illustrates a number of systems and methods that allow touch-typing on multi-touch sensing surfaces.

Touch-Typing on a Multi-Touch Sensing Surface

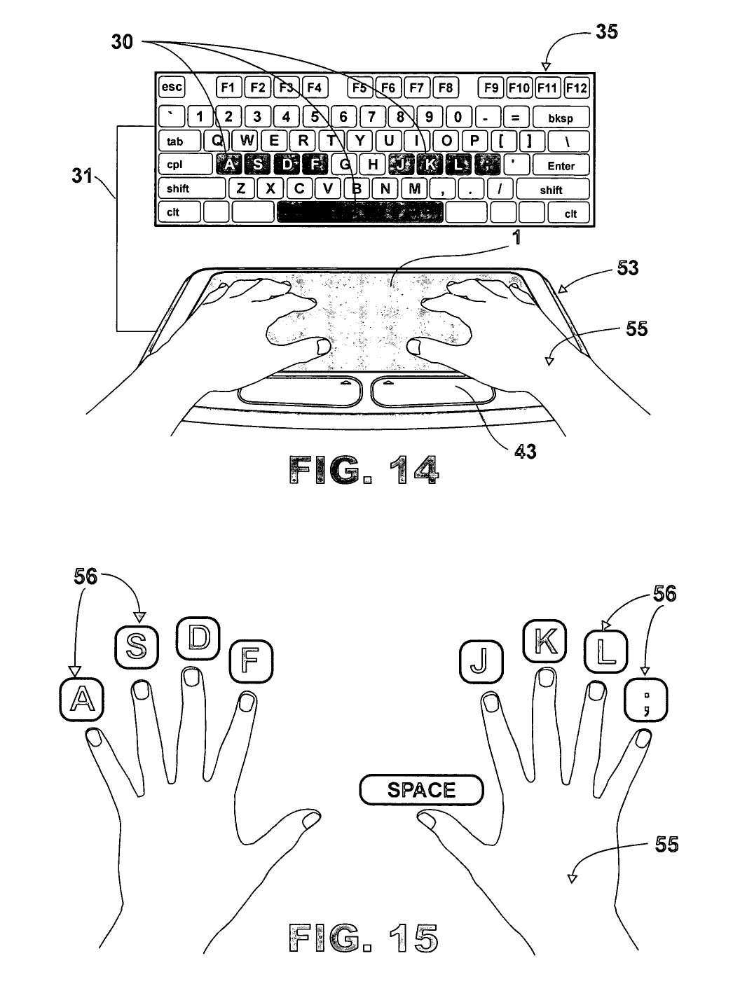

Normally, for the correct typing positions on a QWERTY keyboard layout, from the left hand to the right hand, the fingertips should rest on the A, S, D, F, and J, K, L, ; keys. According to one exemplary embodiment, when incorporating a multi-touch sensing device (53) operating in a virtual typing mode as in FIG. 14, when the operator rests both hands (55) on the sensing surface (1), a computing device (not shown) will automatically arrange each key position as though the operator has placed their fingers in the correct QWERTY position. Additionally, the right thumb is assigned the ‘space’ key. During operation of the exemplary multi-touch sensing device (53), the operator would see a soft keyboard (35) and highlighted keys 30 on the display screen. The soft keyboard (35) can appear in any language and in any size. Moreover, the key positions and the labels of the soft keyboard (35) can be customized as desired.

As stated previously, a preferred sensing surface device would be able to detect hand shapes, hand locations, and reject palm detection. When detecting fingertips, the computing device will assign a reference key (56) to each fingertip as shown in FIG. 15.

If the exemplary multi-touch sensing device (53) can only detect fingertips and palms, the computing device will have no way of identifying the operator's left-hand from their right-hand. According to this exemplary embodiment, in order to operate in the touch type mode, the exemplary multi-touch sensing device (53) uses a left half region and a right half region in such a manner as to distinguish the operator's hands (55). Therefore, by initially placing four fingers on the left half of the device (53), the computing device will register these fingers as from the left-hand, and vice versa.

The computing device will not typically be able to identify a finger as an index finger, a middle finger, a ring finger, or a little finger, unless it is integrated with a hand shape detection mechanism. However, a number of options are available to resolve this shortcoming. According to one exemplary embodiment, the computing device can identify fingers from the middle of the sensing surface device (53), by scanning to the left and right. The first finger detected by the computing device will be registered as ‘F’ for the left region and then ‘D’ for the next one and so on. The computing device will identify fingers in a similar manner for the right region of the device (53). Once the computing device has identified which hand the fingers belong to, it will automatically exclude the thumb position, which is normally lower and assign it to the ‘space’ key.

While the above paragraph illustrates one exemplary key identifying method, the identifying rules can be customized as desired by the operator. By way of example, an operator can set for the ‘space’ key for the right-hand thumb if preferred. Additionally, a disabled operator can set to omit certain finger assignments if some fingers are not functioning or missing. Moreover, the operator may prefer to start the resting positions differently. These modifications to the key identifying method can be altered and recorded through the software settings.

Once the resting positions are identified and all fingers have their reference keys (56) as illustrated in FIG. 15, which operation will happen in a split second without lifting fingers (except the thumbs) from the device (53), the operator will be allowed to move fingers and hands around while the reference key positions remain unchanged.

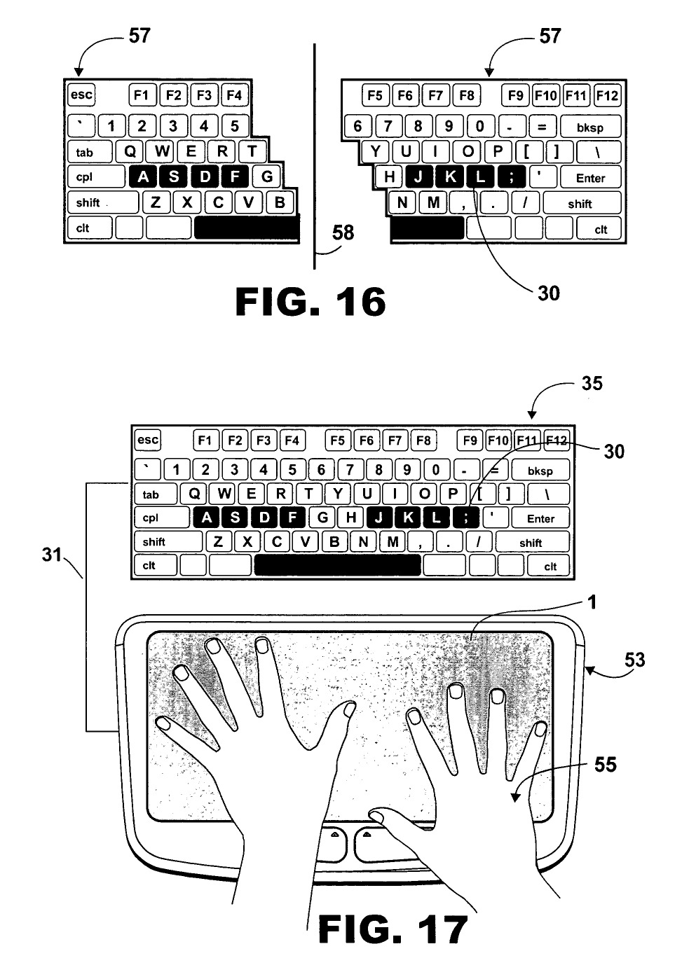

According to one exemplary embodiment, the sensing surface device (53) is divided into two zones, one for each hand, to increase ease of operation. FIG. 16 illustrates how the sensing surface device (53) is conceptually zoned when both hands are presented on the sensing surface device (53). As shown in FIG. 16, each hand controls its own zone, the left hand controls the ‘left zone’ and the right hand controls the ‘right zone’. These zones are called ‘touch-type zones’ (57). Although, the sensing surface device (53) is separated conceptually with a solid line (58), on the display no such line exists.

According to one exemplary embodiment, the operator may rearrange his/her fingers to make them more efficient for typing by aligning fingertips to simulate a hand resting on a physical keyboard. Nevertheless, it is possible to type by laying hands (55) in any non-linear orientation as shown in FIG. 17. Because each hand controls its own zone (57), typing can be performed independently from each hand without regard to the relative location of each hand. Therefore the left and right hands do not have to be aligned with each other, allowing the operator to type with both hands independently on any area of the sensing surface (1). This configuration creates flexibility, versatility, and greater convenience than on a physical keyboard. Even when not linearly oriented, as shown in FIG. 17, the reference keys (56), shown as highlighted buttons (30), remain unchanged on the soft keyboard (35).

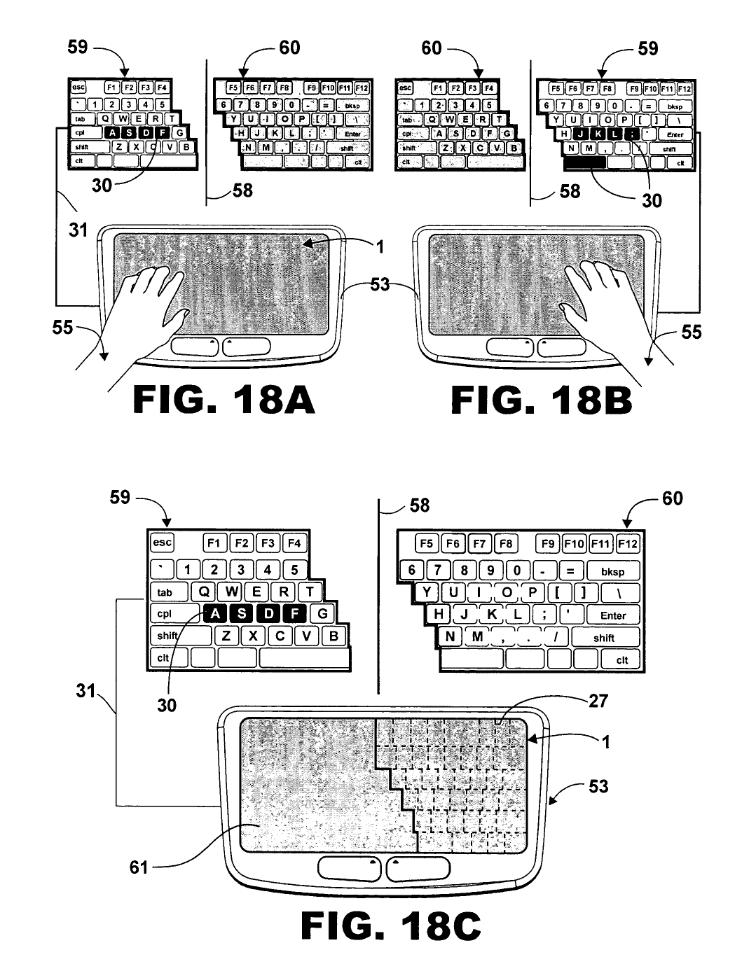

FIGS. 18A and 18B illustrate how typing with one hand can be zoned with the active space mode. According to one exemplary embodiment, when only the left hand is present on the sensing surface (1) as shown in FIG. 18A, the right hand zone becomes an active space zone (60). Consequently, the operator can touch type on the left hand zone (59) and browse with active space on the right hand zone (60). Conversely, when only the right hand is present as illustrated in FIG. 18B, the left hand zone becomes an active space zone (60). FIG. 18C simulates the situation illustrated in FIG. 18A but shows no left hand on the device (53). As shown, the right side of the sensing surface (1) is operating in an active space mode. The imaginary line (27) shows a division of active object mapping according to the active space zone (60). The touch-typing zone (59), will correspond with the area (61) of the left half of the sensing surface (1). The button mapping method on area (61) according to touch-typing mode will be explained shortly.

By allowing half zone configurations, touch-typing with one hand will be possible. The highlights will be shown only on one side of the soft keyboard, depending on which hand is placed. In addition, when only one hand is used, the soft keyboard of the opposite zone (57) will be functioning in the active space mode. In the active space mode, the operator will not be able to touch type, but browsing with multiple fingers can be done easily. The main difference between active space and virtual touch-typing modes are the process performed by the sensing device (53) and the computing device in mapping typewriter keys onto its sensing area (1).

When operating in active space mode, the mapped keys are fixed initially at the first touch. After the mapped keys are initially fixed, movement of the highlighted keys is initiated by movement or sliding of the operator's fingers. Once the desired key is identified, typing is achieved by pressing the virtual button. In contrast to the active space mode illustrated above, when operating in the touch-typing mode, the operator's fingers are first detected as reference keys (56). Subsequent sliding of the hands and fingers will not change the highlighted keys (30).

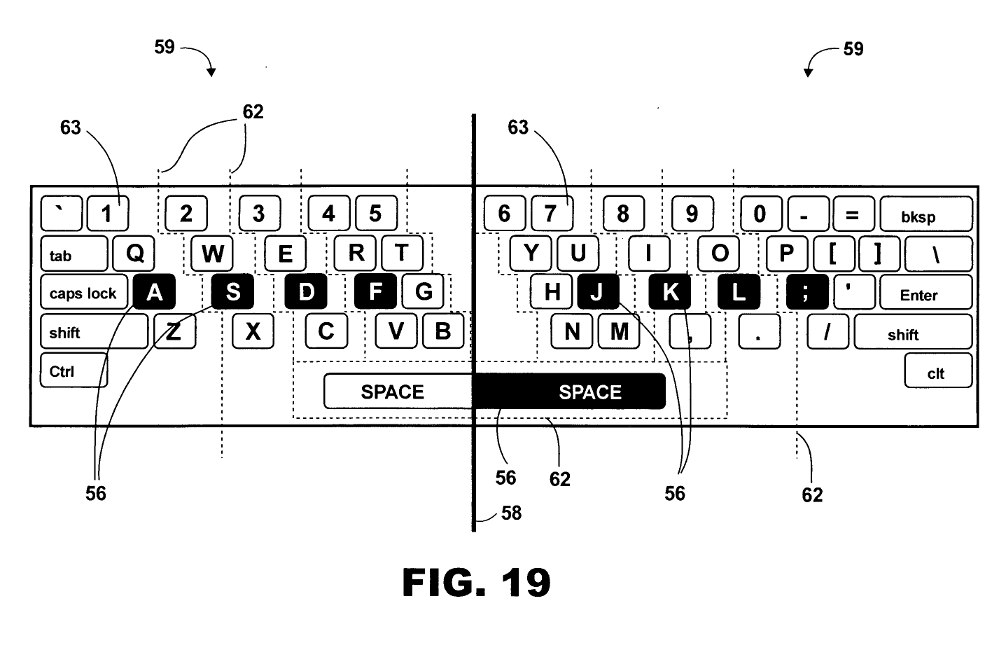

FIG. 19 illustrates how keys are subdivided into touch-type zones (59) according to one exemplary embodiment. As illustrated in FIG. 19, once reference fingers (reference keys 56—‘A, S, D, F, J, K, L, ;, and space) have been identified, the computing device will assign associated keys (63) for each reference key (56). According to touch-typing convention, each finger may then be used to type a particular set of keys. The assigned sets of keys are graphically separated in FIG. 19 with a dotted line (62). According to the exemplary embodiment illustrated in FIG. 19, the little finger of the left hand would have the button ‘A’ as its reference key (56), and buttons ‘′’, ‘1’, ‘tab’, ‘Q’, ‘caps’, ‘shift’, ‘Z’, and ‘ctrl’ are its associated keys (63). According to one exemplary embodiment, these keys can be differentiated by grouping with the same color on the display soft keyboard.

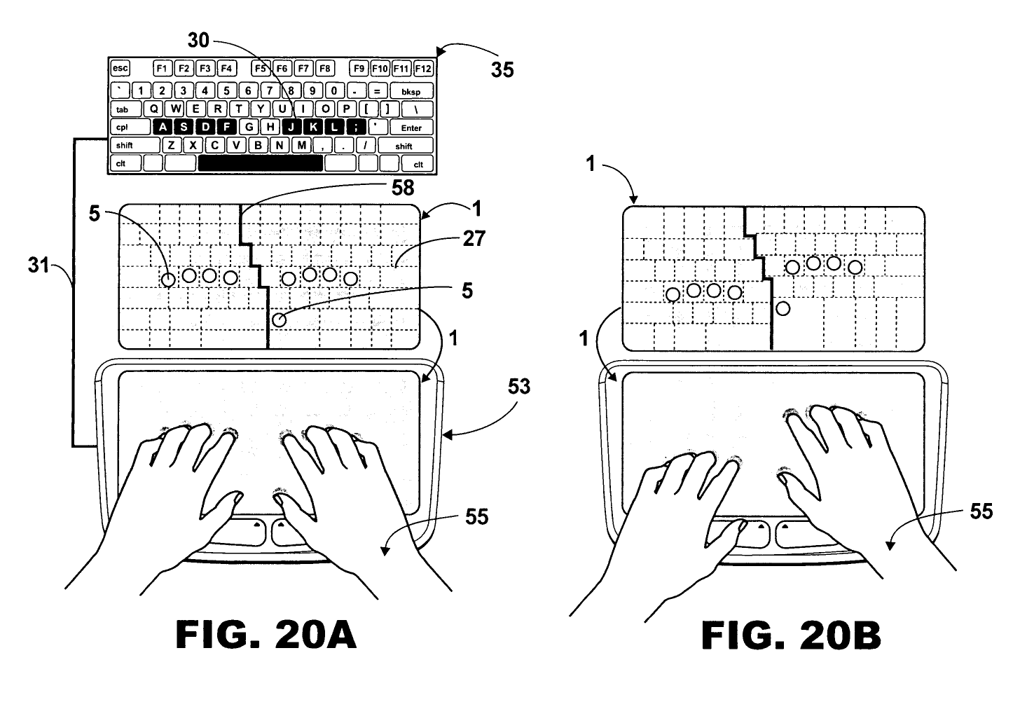

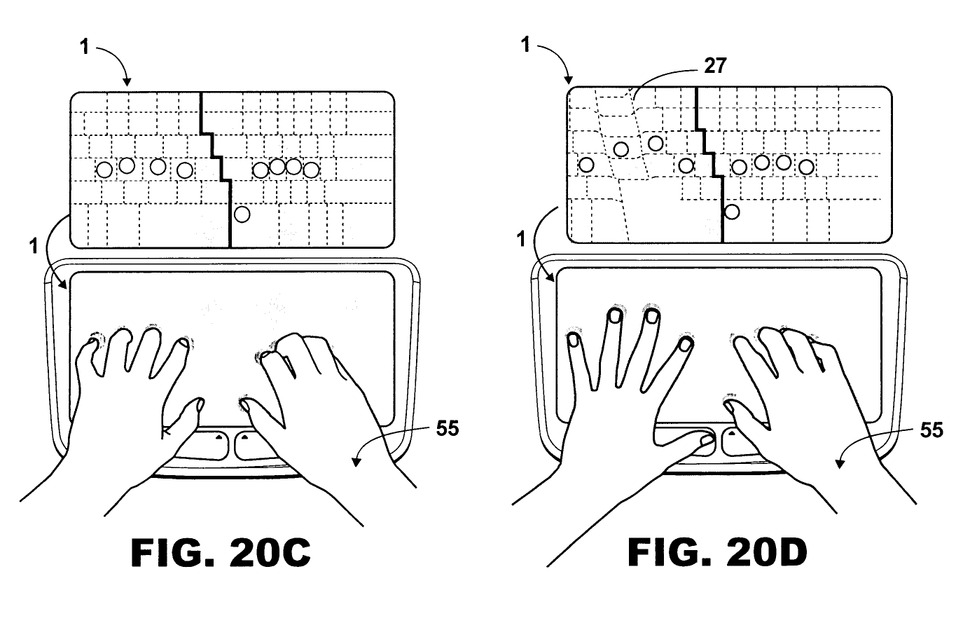

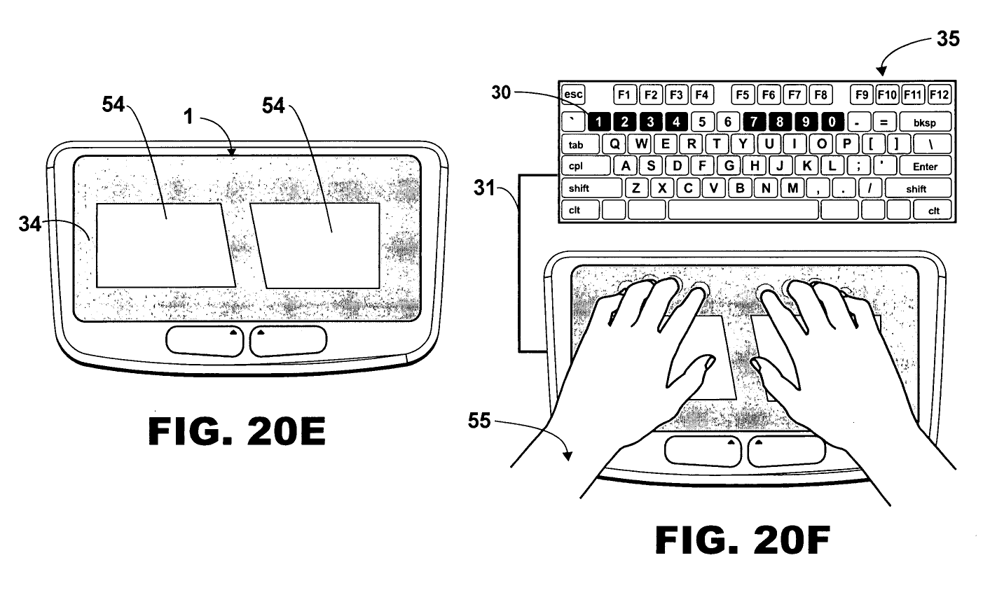

FIG. 20A illustrates key mapping dividing the individual keys by dotted line (27) on the sensing surface (1). The white circles representing finger marks (5) in FIG. 20A are current fingertip positions of both hands (55) that are resting on the same sensing surface (1) of the input device (53). The finger marks (5) illustrated in FIG. 20A are resting on reference keys (56; FIG. 19), and are shown as highlighted buttons (30) that the operator would see on a soft keyboard (35) represented on the display screen. FIG. 20A to 20D illustrates the dynamic button mapping that may occur when finger positions on the sensing surface (1) change. FIG. 20B illustrates that the left and right hands are not aligned. Accordingly, the key mapping positions change across the surface (1). The finger marks (5) still rest on the reference keys that are ‘A, S, D, F, and J, K, L, ;, space.’ FIG. 20C illustrates the left hand fingers stretched apart while the right hand fingers are closed to each other. The keys mapping on the left zone stretches apart as shown in the figure, and the keys mapping on the right zone cram closer. As shown in FIG. 20D, the left hand fingers are not aligned on the sensing surface (1), however, the finger marks still rest on the reference keys, causing each set of associate keys to change their positions. Regardless of the finger positioning, the associated keys for each finger set will always try to be the same distance apart on the sensing surface by measuring from the setting reference finger. According to one exemplary embodiment, the distance separating the associated keys is factory set to simulate the conventional keyboard size and may be adjusted depending on the size of the sensing surface (1) and the size of the operator's hands. Again, the actual positions of these keys are not shown on the display screen, unless set to do so. Also, the associated keys convention can be customized and regrouped as requested by the user.

The keys will be mapped on the sensing surface (1) based at least in part on the original location of the reference fingers. Overlapping keys' space will be divided equally to maximize each clashing key's area as seen in FIG. 20C on the right side of the sensing surface (1). If the reference fingers are far apart causing gaps between a number of keys, these gap spaces will be divided equally to maximize each key's area as seen in FIG. 20C and FIG. 20D on the left side of the sensing surface (1). Notice on FIG. 20D that in order to maximize each key's area, the dotted line (27) indicating the key's boundaries became slanted due to the keys' gap division.

According to one exemplary embodiment, the key mapping illustrated above may not necessarily result in rectangular key space divisions. Rather, the key space divisions may take on any number of geometric forms including, but in no way limited to, a number of radius or circular key space divisions, where the keys' area overlapping results will be divided in half.

According to one exemplary embodiment, an operator will be warned or will be automatically provided with the active space typing mode if any associated keys are highly overlapped. For example, if a number of fingers are not aligned in a reasonable manner for touch-typing (e.g. one finger rests below another), both hands are too close to each other, or the hands are too close to the edges. These occasions may cause keys missing on the sensing surface 1 as seen in FIGS. 20B and 20D. In FIG. 20B, on the right side of the sensing surface (1), one can carefully observe that the entire row of special keys (F5 to F12) are missing. Similarly, in FIG. 20D, on the left side of the sensing surface (1), ‘tab’, ‘′’, and the special keys (Esc to F4) are missing.

Two exemplary solutions that may remedy the missing keys condition include: first, if the hands/fingers move in any configurations that cause missing keys, automatically switch to the active space typing mode. Second, as illustrated in FIG. 20E, the sensing surface (1) may be labeled with resting regions (54) which indicate preferred areas where the reference fingers should be located. The resting regions (54) disposed on the sensing surface (1) ensure that the hands are not in a position likely to cause missing keys such as a position that is too close to the edges or too close to each other.

FIG. 20F illustrates an exemplary implementation where the fingers are rested on gray area (34) outside of the resting region (54). Notice that the highlighted keys (30) are no longer the reference keys, but the number keys. In fact, when the condition illustrated in FIG. 20F occurs, the present system may operate in the active space typing mode, allowing the operator to rest fingers on the number row keys.

As shown in FIGS. 18A, 18B, and 20A, by placing hand(s) in the resting position for touch-typing, with four fingers present from each hand (excluding the thumb), the computing device will automatically switch to the touch-type mode. If, however, the operator does not rest four fingers (excluding the thumb), thereby enabling the computing device to set the reference fingers (e.g. when only one or two fingers present), the active space typing mode is provided.

In the touch-typing mode, the left-hand will operate keys in column ‘Caps Lock, A, S, D, F, G’ and the right-hand will operate keys in column ‘H, J, K, L, ;, ‘Enter’. To actually type a letter, the ‘virtual button,’ as seen in FIGS. 2 to 4, must be pressed. If the sensing surface is a hardboard type, a signal such as sound would indicate a Sₙ input.

When an operator rests four fingers thereby activating the touch type mode, the highlighted keys will be the reference keys. With the reference keys designated, the operator is now allowed to type by lifting the fingers as traditionally done or by just sliding fingertips. However, for sliding, at least one of the fingers, excluding the thumb in that hand, must be lifted off from the sensing surface (1). Removal of at least one finger from the sensing surface is performed in order to freeze the keys mapped on the sensing surface (1).

According to one exemplary embodiment, once the reference keys are set on either hand, left for example, lifting any left hand finger would freeze all the key positions in the left-hand zone but will not freeze the right hand zone keys. This embodiment will allow the operator to type any intended key easily by lifting the hands entirely or partially, or sliding. Although, there are recommended keys for certain fingers, one can type ‘C’ with the left index finger. However, this may be difficult depending on the initial distance between the middle finger and the index finger of the left hand before the freeze occurred.

The freeze will timeout in a designated period if no finger presents, and no interaction occurs. The timeout period may vary and/or be designated by the user. When both hands are no longer on the sensing surface (1), the soft keyboard disappears.

The operator can perform the virtual touch-typing mode with one hand (four fingers present or in the process of typing) and perform active space with another hand (browsing letter with one or two fingers), as shown in FIGS. 18A to 18C.

Every time the operator rests the four fingers on one hand back to or near to all the reference keys positions where they were last frozen, all key positions (keys mapping) of that hand-zone will be recalibrated. In fact, according to one exemplary embodiment, recalibration may occur every time the operator places his/her fingers back to the reference positions in order to ensure a smooth typing experience.

The soft keyboard (35) may be displayed merely as a reminder of the position of each key. The soft keyboard (35) does not intend to show the actual size or distance between the keys, although according to one exemplary embodiment, the soft keyboard (35) can be set to do so. For a skilled touch-type operator, the soft keyboard (35) can be set to display in a very small size or set to be removed after the feedback has indicated which reference keys the user's fingers are on.

Returning now to FIGS. 7C and 7D, these FIGS. illustrate an exemplary method for the logical sequences that occur during a virtual touch-typing interaction method. As shown in FIG. 7C, the active space interaction mode illustrated in FIGS. 7A and 7B are performed (a-h). Once performed, the computing device determines if four fingers are detected in the resting regions (aa). If not, the active space process illustrated in steps (i-s) of FIG. 7B are performed. If, however, four fingers are detected in the resting regions, a reference key position for each reference finger is determined, the appropriate keys are highlighted on the soft keyboard, and the associated keys location is determined for each reference finger (bb). Once these key locations are determined, the computing device determines whether any keys are missing due to area constraints (cc). If any keys are missing, the active space process illustrated in FIG. 7B is performed. If, however, there are not any keys missing, key selections are detected (dd). If the selection of a key is detected, the input data is recorded. If, however, no key selection is detected, the computing device senses for the movement of fingers (ff), the movement of fingers outside the resting region (gg), or the removal of fingers (hh) from the sensing surface as described above. If the computing device senses the removal of a finger (hh), all the key positions are frozen (ii) and the computing device determines if a key selection has been made (jj). If so, the data input is recorded, interactive feedback is performed, and any clocks are deactivated (kk). If however, the computing device does not determine that a key selection has been made, the computing device then determines if the fingers have been moved, lifted off of the sensing surface, and then touched down on a different location (ll). If such a selection is sensed by the computing device, the newly selected keys are determined, the appropriate keys on the soft keyboard are highlighted, and any active clocks are deactivated as the computing device returns again to block (jj). If, however, the fingers have not been moved, lifted off of the sensing surface, and then touched down on a different location (ll), the computing device checks for a first (nn) or second (pp) clock time out, which if detected will restart the present method (oo, qq). If, however, neither clock time out is detected, the computer checks to see if all four fingers are present in the resting regions and if a first clock is dormant (rr). If so, the first clock is activated (ss) and the present method begins again at block (jj) (uu). If, however, block (rr) is negative, the computing device then determines if all four fingers are missing and a second clock is dormant (tt). If so, the method returns to block (jj). If not, the four fingers are checked for their last reference key position (ww). If they are there, the process begins again by deactivating the clocks and returning to block (bb). The method illustrated above and in FIGS. 7C and 7D are merely exemplary embodiments of the present system and method and in no way limit the present system and method to the embodiments described.

Moreover, according to one exemplary embodiment, a password typing mode may be presented. According to this exemplary embodiment, a number of visual feedbacks (e.g. inputting highlight) may be omitted when typing a password. The computer will recommend typing in the touch-type mode since browsing letters with the active space mode may reveal the password to an onlooker (e.g. when the display is large).

Moreover, the present virtual touch-type and active space modes are well suited for use on a handheld PC, since its small size will not allow touch-typing with the normal mechanical keyboard. Additionally, the software hosting the present system and method will dynamically adjust positions of the keys according to the current operator's finger position and hand-size. According to this exemplary embodiment, the software can learn to adapt to all kinds of hands during word processing, this is contrary to other existing systems where the operator is forced to adapt to the system.

The present system and method also allows an operator to focus only on the display screen while interacting with a computing device. Consequently, those who do not know how to touch-type can type faster since they no longer need to search for keys on the keyboard, and eventually will learn to touch-type easily. Those who are touch-typists can also type more pleasantly since the software can be customized for their unique desires.

The present user interface models, active space methods, and virtual touch-typing methods may also be applied to simulate various kinds of traditional switch panels. For example, numeric keypads, calculator panels, control panels in the car, remote controller panels, and some musical instrument panels such as piano keyboards. Moreover, the present system and method may be incorporated into any device including, but in no way limited to, household devices such as interactive TV, stereo, CD-MP3 players, and other control panels. Moreover, the sensing surface of the present system and method can be placed behind a liquid crystal display (LCD) device, allowing the visual key mapping process to be performed in real time thereby further aiding with computing interaction. As can be illustrated above, there is no limit to the application of the present system and method using a single input device.

Multiple Pointer Interaction Mode

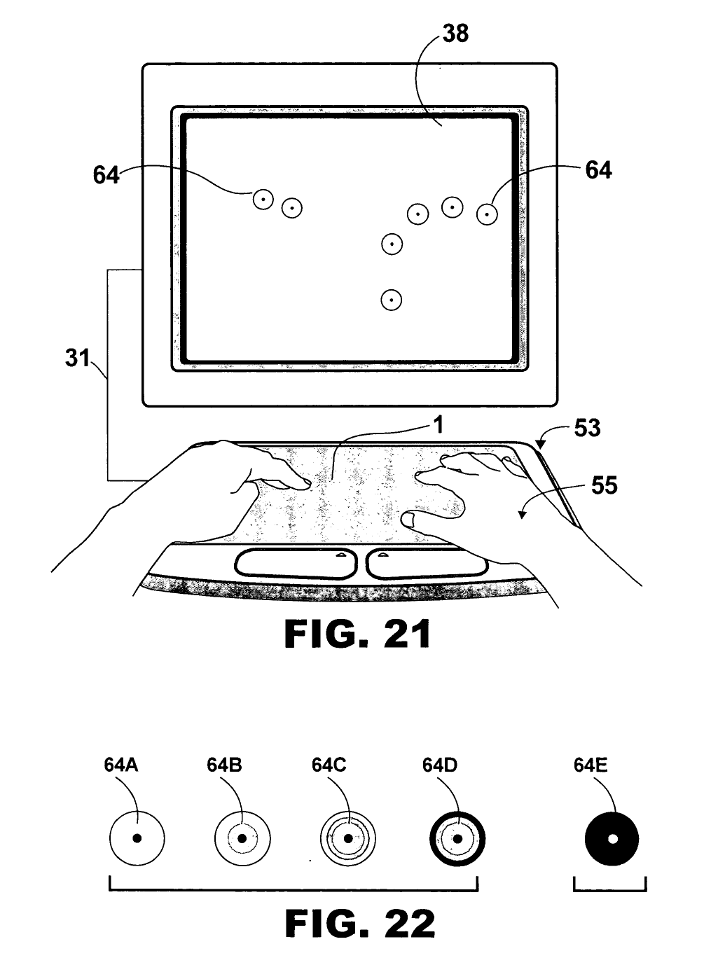

FIG. 21 illustrates multiple pointers (64) on a display screen (38). The multiple pointers (64) represent fingertips, which are sensed by the sensing surface (1). The locations and displacements of these pointers will depend on the movement of the operator's fingers and hands (55) on the sensing surface (1).

FIG. 22 shows that according to one exemplary embodiment, the pointers (64A to 64D) will have different appearances according to the changes in pressure detected from each fingertip (z value) on the sensing surface (1). The pointer (64E) has the most distinct features, which indicates that an indentation sufficient to make a selection was made on the surface or when (Sₙ=1).

The motion of the pointers in multiple pointers mode simulates the actual hand and finger motion. The motion of the pointers, however, also depends on the size of the sensing surface and its geometry, which in turn are relative to the viewing screen geometry. Note also that the pointers disappear when there are no fingers on the sensing surface.

Shortly after at least one finger presses the sensing surface (1) and causes a selection signal Sₙ=1, the movement of other pointers from the same hand will be interpreted by the computerized systems as any number of programmed gestures corresponding to the pointer movement. Programmed gestures may include, but are in no way limited to, press to make selection (e.g. close window), press then twist hand to simulate turning a knob gesture, press then put two fingers together to grab object (equivalent to mouse drag gesture), press then put three or four fingers together to activate vertical and horizon scrollbar simultaneously from any location in the window, press then put five fingers together to activate title bar (as to relocate window) from anywhere in the window.

As shown above, the gesture method allows elimination of the basic user interface such as a title bar and a scrollbar into one simple intuitive grabbing gesture. Other functions such as expanding or shrinking windows can also be performed easily using intuitive gestures. Accordingly, the present multiple pointer interaction mode simulates placing the operator's hands in the world of software. Additionally, the present multiple pointer interaction mode allows an operator to perform two gestures at the same time e.g. relocating two windows simultaneously to compare their contents.

According to one exemplary embodiment, the above-mentioned hand gestures can be interpreted from two hands as well as one. For example, performing a grab gesture in a window and then moving hands to stretch or shrink the window. Alternatively, a user may press one finger on an object, then press another finger from the different hand on the same object and drag the second finger away to make a copy of the selected object.

Besides, being able to perform gestures with visual feedback, software can be created for specific applications such as a disc jockey turntable, an advance DVD control panel, and/or an equalizer control panel. These applications are not possible with traditional input devices.

Mini-Hands Interaction Mode

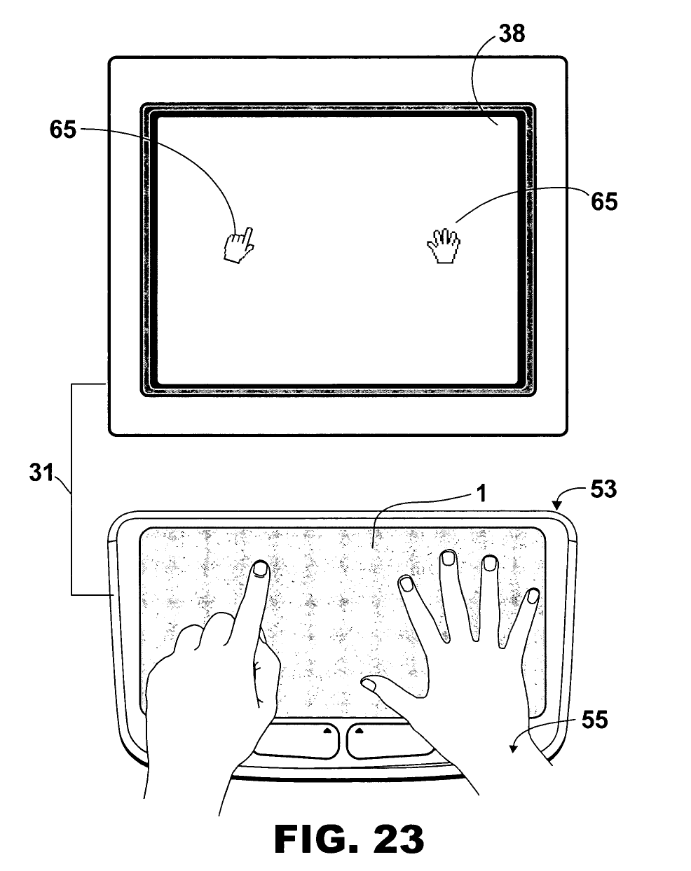

The above-mentioned multiple pointer mode is particularly suited to larger computing systems such as desktop PCs. However, having up to ten pointers floating on a display screen can be confusing. The mini-hands interaction mode eliminates the multiple pointers by displaying a mini-hand cursor for each operator's hand. Unlike common single pointer cursors, each finger on the mini-hand will simulate the finger of the operator hand. Additionally, unlike multiple pointers mode, the computerized systems will gain extra information by knowing the state of the mini-hand. For example: laying down five fingers on the sensing surface indicates that the mini-hand is ready to grab something, placing only one finger on the sensing surface indicates that the mini-hand is to be used as a pointer. FIG. 23 shows a display screen (38) including two mini-hands (65) to illustrate the present system and method. Notice on the left hand (55) only one finger is detecting by the sensing surface (1) so the corresponding mini-hand (65) shows a pointing gesture on the screen (38).

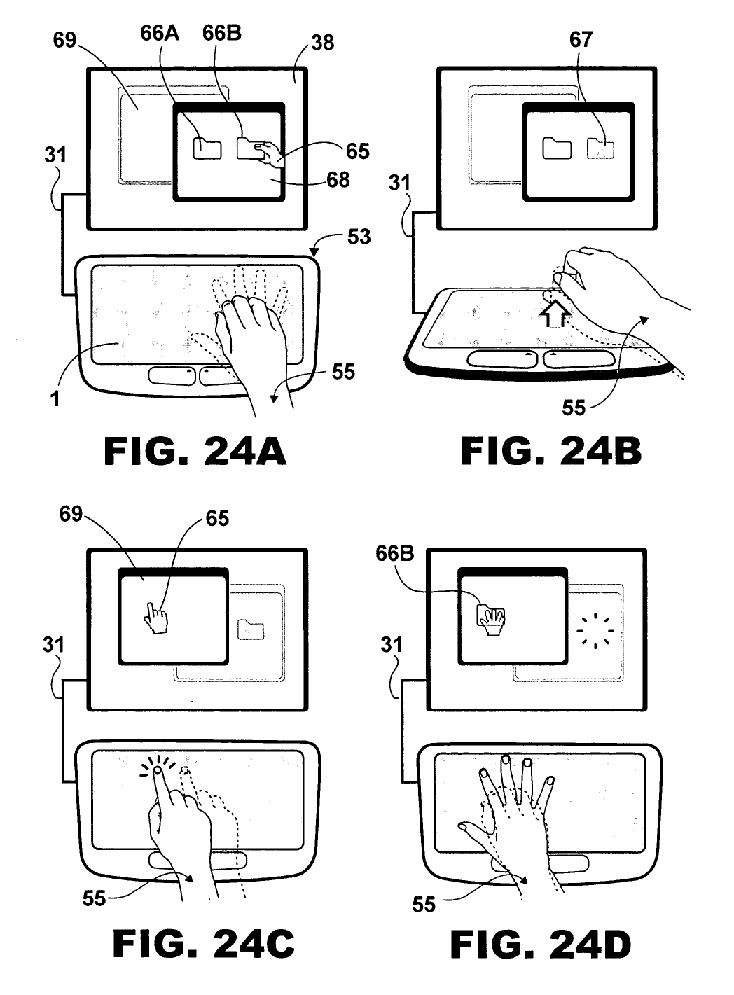

FIGS. 24A to 24D further illustrate an implementation of the mini-hands interaction mode according to one exemplary embodiment. In FIG. 24A, the right mini-hand (65) performs a grabbing gesture on a folder/directory (66B). Accordingly, the window (68) is a current active window, and window (69) in an inactive window. FIG. 24B illustrates the operator shortly lifting his hand (55) off of the sensing surface (1). The computerized system interprets this continuous gesture as cut operation according to one exemplary embodiment. At this point, the operator would feel as though the folder was lifted off of the sensing surface (1). The folder (66B) in FIG. 24A turned faint as shown in FIG. 24B to indicate that this folder (67) is being cut. Note that mini-hand disappears in FIG. 24B since no hands or fingers are detected on the sensing surface (1). In FIG. 24C, the mini-hand (65) reappears to activate the background window (69) with a selecting gesture. Additionally, FIG. 24D illustrates the operator starting with fingers together, pressed on the sensing surface (1) then gently spreads fingers apart to indicate a paste operation. Consequently, the folder (66B) was relocated to a new window. Notice from FIG. 24A to 24D that the continuous gesturing is much like how we function our hands in the real world.

Chameleon Cursor Interaction Mode

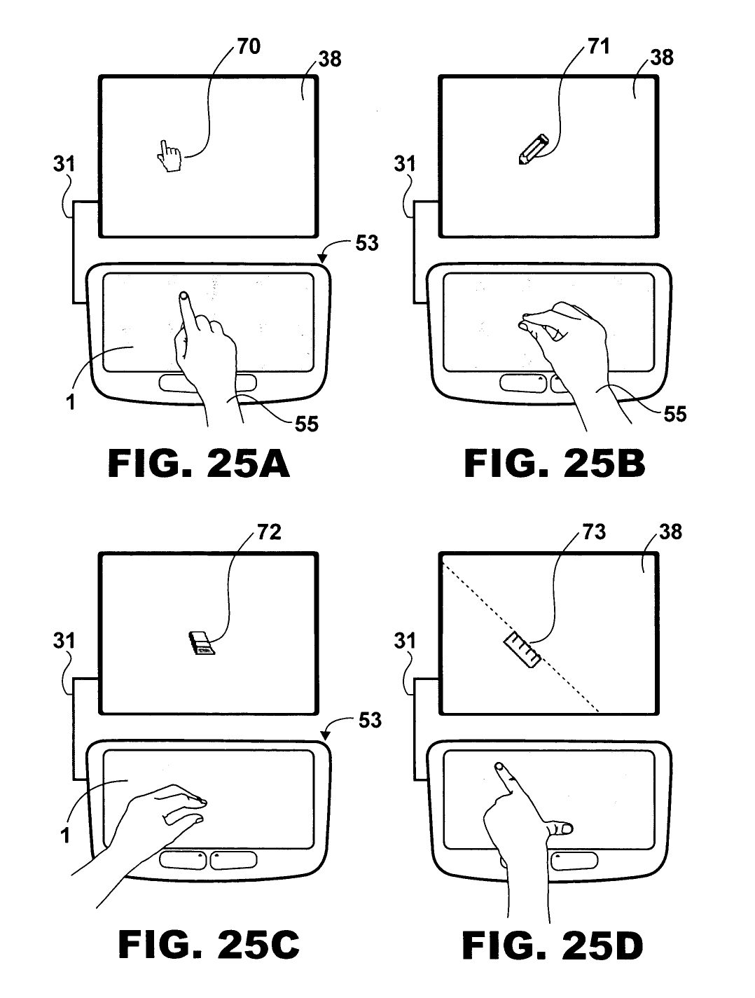

The chameleon cursor interaction mode illustrated in FIGS. 25A through 25D takes full advantage of a sensor input device that is able to detect for multiple fingers, palms, and hands. According to one exemplary embodiment of the chameleon cursor interaction mode, the input device quickly interprets hand configurations and produces a unique characteristic cursor in response. For example, FIG. 25A illustrates that when a single fingertip and a palm are detected from one hand, the cursor become a pointer (70). Similarly, FIG. 25B illustrates that when two fingertips are detected together with a palm as shown in FIG. 25B, the cursor become a pencil (71) and can be use to do freehand drawing. When three fingertips and no palm are detected as shown in FIG. 25C, the cursor become an eraser (72). As shown in FIG. 25D, two fingertips sensed apart with a palm becomes a ruler (73).

From the examples illustrated above, the present chameleon cursor interaction mode may be used in any number of programs. For example, the chameleon cursor interaction mode illustrated above may be very useful for a drawing program.

Although the description above contains many specifics, these should not be construed as limiting the scope of the system and method but as merely providing illustrations of some of the presently preferred embodiments of this system and method. For example, the mini-hand may appear as a leaf, or a starfish instead of a human hand alike, the soft keyboard on a mobile phone display may not layout similar to a conventional keyboard, the sensing surface may have features and feel much like conventional switch panel or keyboard, the sensing surface can be installed together with LCD or a display as one device, the chameleon cursor can be used with word processing program to quickly change from typing mode to drawing mode etc.

Tablet Cursor Interaction Mode

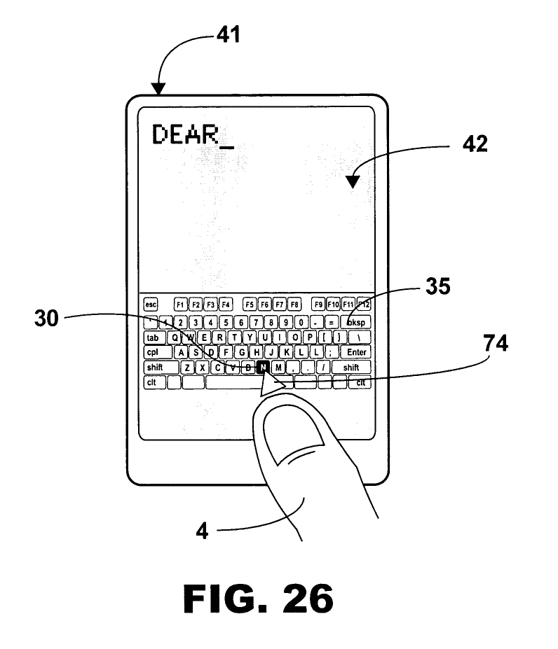

Unlike the previously described interaction modes, the tablet cursor interaction mode illustrated in FIG. 26 is to be used specifically with a touch screen system. The rules of user interface when incorporating the present tablet cursor interaction mode are similar to that when using a mouse cursor. FIG. 26 illustrates a tablet cursor incorporated in a personal digital assistant (PDA) (41) touch screen system. When the operator places a finger (4) on the touch screen (42), a cursor (74) appears above the touched finger. According to one exemplary embodiment, the cursor visibly appears on the touch screen (42) in a location close to the touched finger. According to this embodiment, the cursor always follows the operator's touched finger (4). As shown in FIG. 26, the operator is making selection for letter N on a soft keyboard (35) by using the virtual button mechanism explained previously.

Like a cursor of a mouse icon, the cursor (74) used in the present tablet cursor interaction mode can be interchanged automatically. For example, according to one exemplary embodiment, the cursor (74) may change from a pointer (arrow) to an insert cursor (|) while working with word processor software.

Additionally, the present tablet cursor interaction mode illustrated in FIG. 26 can incorporate and otherwise take advantages of the other modes, previously described. The ability of the present tablet cursor interaction mode to incorporate and otherwise take advantage of the other previously described modes may depend on the capability of the input device used.

In conclusion, the present exemplary systems and methods allow a computer to do so some much more even if it is very small in size. Many restrictions that normally hinder the communication between a human and a computer can be removed. One input device can be used to replace many other input devices. The present system and method provides a human computer interaction method that can exploit the dexterity of human hands and fingers using touch sensing technology for every type of computing device. The present system and method also provide a simple, intuitive, and fun-to-use method for word processing on small computing devices such as a mobile phones, digital cameras, camcorders, watches, palm PCs, and PDAs. Additionally, this method is faster to operate than any other existing system, and does not require new learning. The present system and method also provide a method for word processing by touch typing or browsing without using a mechanical keyboard by providing a direct manipulation method for human computer interaction. Using the above-mentioned advantages, the present system and method provides the possibility of creating even smaller computing devices.

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

1. A data input device comprising:
a finger touch sensing surface;
wherein said finger touch sensing surface is configured to produce a visual feedback in response to a touching of said touch inputs, said visual feedback corresponding to an absolute location that said finger touch sensing surface was touched by a finger.

2. The data input device of claim 1, wherein said data input device is configured to provide a function of a traditional input device.

3. The data input device of claim 2, wherein said function of a traditional input device includes a functionality of one of a mouse, a keyboard, a stylus, or a touch screen.

4. The data input device of claim 1, wherein said finger touch sensing surface comprises one of a virtual switch device, a touch pad, an air gap virtual switch, of a rubber feet virtual switch, a peripheral switch, or a touch strength detector.

5. The data input device of claim 1, wherein said visual feedback comprises one of an icon on a visual display or a highlighted key on a virtual keyboard.

6. The data input device of claim 5, wherein said virtual keyboard comprises one of a QWERTY keyboard or a cell phone keypad.

7. The data input device of claim 1, wherein said finger touch sensing surface is configured to:
simultaneously sense a touching of multiple fingers; and
produce an independent visual feedback corresponding to an absolute position of each of said multiple fingers on said finger touch sensing surface.

8. The data input device of claim 7, wherein said data input device is configured to perform a functionality of a keyboard.

9. The data input device of claim 8, wherein said visual feedback comprises a highlighting of a key on a virtual keyboard.

10. The data input device of claim 8, wherein said finger touch sensing surface further comprises a textured surface, wherein said textured surface simulates keys of a “QWERTY” keyboard.

11. The data input device of claim 1, wherein said data input device is further configured to:
interpret an active graphical display; and
map a plurality of selectable objects relative to an area of said finger touch sensing surface, wherein said selectable objects may be interactively selected by touching a corresponding location on said touch sensing surface.

12. The data input device of claim 11, wherein said selectable objects comprise buttons graphically represented on a display device.

13. The data input device of claim 12, wherein said buttons comprise cell phone keypad buttons.

14. The data input device of claim 12, wherein said buttons comprise keyboard buttons.

15. The data input device of claim 12, wherein said data input device is further configured to:
assign an initial button to each finger that touches said finger touch sensing surface; and
modify said assigned button in response to a movement of said finger.

16. The data input device of claim 15, wherein said initial button assignment comprises assigning a plurality of reference keys to an initial finger placement.

17. The data input device of claim 16, wherein said plurality of reference keys comprise an “A,” an “S,” a “D,” an “F,” a “J,” a “K,” an “L,” and a “;” key.

18. The data input device of claim 17, wherein said data input device is further configured to:
arrange a remaining set of keys on a traditional keyboard in a spatial relationship to said plurality of reference keys.

19. The data input device of claim 17, wherein said plurality of reference keys are assigned in a non-linear configuration.

20. The data input device of claim 15, wherein said assigned button modification comprises:
sensing an absolute position change of a sensed finger in a first direction; and
changing said button assignment from said initial button to a button adjacent to said initial button in said first direction.

21. The data input device of claim 1, wherein said data input device is configured to form a part of one of a phone, a watch, a palm personal computer (PC), a tablet PC, a PC, a thumb keyboard, a laptop, a digital camera, a camcorder, a personal digital assistant (PDA), a web slate, an e-Book, a global positioning system (GPS) device, a video game, a remote control, an audio/video remote control, a multimedia asset player (MP3, video), or a Kiosk terminal.

22. The data input device of claim 1, wherein said finger touch sensing surface comprises a plurality of touch type zones.

23. A data input device comprising:
a finger touch sensing surface;
wherein said finger touch sensing surface is configured to produce a visual feedback in response to a touching of said touch inputs, said visual feedback corresponding to an absolute location that said finger touch sensing surface was touched by a finger; and
wherein said finger touch sensing surface is configured to simultaneously sense a touching of multiple fingers and produce an independent visual feedback corresponding to an absolute position of each of said multiple fingers on said finger touch sensing surface.

24. The data input device of claim 23, wherein said data input device is configured to provide a function of a traditional input device.

25. The data input device of claim 24, wherein said function of a traditional input device includes a functionality of one of a mouse, a keyboard, a stylus, or a touch screen.

26. The data input device of claim 23, wherein said finger touch sensing surface comprises one of a virtual switch device, a touch pad, an air gap virtual switch, a rubber feet virtual switch, a peripheral switch, or a touch strength detector.

27. The data input device of claim 23, wherein said visual feedback comprises one of an icon on a visual display or a highlighted key on a virtual keyboard.

28. The data input device of claim 27, wherein said virtual keyboard comprises one of a QWERTY keyboard or a cell phone keypad.

29. The data input device of claim 28, wherein said finger touch sensing surface further comprises a textured surface, wherein said textured surface simulates keys of a “QWERTY” keyboard.

30. The data input device of claim 23, wherein said data input device is further configured to:
interpret an active graphical display; and
map a plurality of selectable objects relative to an area of said finger touch sensing surface, wherein said selectable objects may be interactively selected by touching a corresponding location on said touch sensing surface.

31. The data input device of claim 30, wherein said selectable objects comprise buttons graphically represented on a display device.

32. The data input device of claim 31, wherein said buttons comprise cell phone keypad buttons.

33. The data input device of claim 31, wherein said buttons comprise keyboard buttons.

34. The data input device of claim 31, wherein said data input device is further configured to:
assign an initial button to each finger that touches said finger touch sensing surface; and
modify said assigned button in response to a movement of said finger.

35. The data input device of claim 34, wherein said initial button assignment comprises assigning a plurality of reference keys to an initial finger placement.

36. The data input device of claim 35, wherein said plurality of reference keys comprise an “A,” an “S,” a “D,” an “F,” a “J,” a “K,” an “L,” and a “;” key.

37. The data input device of claim 36, wherein said data input device is further configured to:
arrange a remaining set of keys on a traditional keyboard in a spatial relationship to said plurality of reference keys.

38. The data input device of claim 36, wherein said plurality of reference keys are assigned in a non-linear configuration.

39. The data input device of claim 34, wherein said assigned button modification comprises:
sensing an absolute position change of a sensed finger in a first direction; and
changing said button assignment from said initial button to a button adjacent to said initial button in said first direction.

40. The data input device of claim 23, wherein said data input device is configured to form a part of one of a phone, a watch, a palm personal computer (PC), a tablet PC, a PC, a thumb keyboard, a laptop, a digital camera, a camcorder, a personal digital assistant (PDA), a web slate, an e-Book, a global positioning system (GPS) device, a video game, a remote control, an audio/video remote control, a multimedia asset player (MP3, video), or a Kiosk terminal.

41. The data input device of claim 23, wherein said finger touch sensing surface comprises a plurality of touch type zones.

42. A computing device comprising:
a processor;
a display screen communicatively coupled to said processor; and
a data input device communicatively coupled to said processor, wherein said data input device includes a finger touch sensing surface, wherein said finger touch sensing surface is configured to produce a visual feedback signal in response to a touching of said touch sensing surface, said visual feedback signal being configured to cause said processor to graphically display a visual feedback on said display screen corresponding to an absolute location that said finger touch sensing surface was touched by a finger.

43. The computing device of claim 42, wherein said computing device comprises one of a cell phone, a PDA, a keyboard, a palm PC, tablet PC, a PC, a watch, a thumb keyboard, a laptop, a camera, a video recorder, a web slate, an e-Book, a global positioning system (GPS) device, a video game, a remote control, an audio/video remote control, a multimedia asset player (MP3, video), or a Kiosk terminal.

44. The computing device of claim 42, wherein said finger touch sensing surface is configured to simultaneously sense a touching of multiple fingers and produce an independent visual feedback corresponding to an absolute position of each of said multiple fingers on said finger touch sensing surface.

45. The computing device of claim 42, wherein said data input device is configured to provide a function of one of a mouse, a keyboard, a stylus, or a touch screen.

46. The computing device of claim 42, wherein said finger touch sensing surface comprises one of a virtual switch device, a touch pad, an air gap virtual switch, of a rubber feet virtual switch, a peripheral switch, or a touch strength detector.

47. The computing device of claim 42, wherein said visual feedback comprises one of an icon on a visual display or a highlighted key on a virtual keyboard.

48. The computing device of claim 47, wherein said virtual keyboard comprises one of a QWERTY keyboard or a cell phone keypad.

49. The computing device of claim 48, wherein said finger touch sensing surface further comprises a textured surface, wherein said textured surface simulates keys of a “QWERTY” keyboard.

50. The computing device of claim 42, wherein said computing device is further configured to:
interpret an active graphical display generated on said display screen; and
map a plurality of selectable objects relative to a dimension of said finger touch sensing surface, wherein said selectable objects may be interactively selected by touching a corresponding location on said touch sensing surface.

51. The computing device of claim 50, wherein said selectable objects comprise buttons graphically represented on said display screen.

52. The computing device of claim 51, wherein said buttons comprise cell phone keypad buttons.

53. The computing device of claim 51, wherein said buttons comprise keyboard buttons.

54. The computing device of claim 51, wherein said processor is configured to:
assign an initial button to each finger that touches said finger touch sensing surface; and
modify said assigned button in response to a movement of said finger.

55. The computing device of claim 54, wherein said initial button assignment comprises assigning a plurality of reference keys to an initial finger placement.

56. The computing device of claim 55, wherein said data input device is further configured to arrange a remaining set of keys on a traditional keyboard in a spatial relationship to said plurality of reference keys.

57. The computing device of claim 55, wherein said plurality of reference keys are assigned in a non-linear configuration.

58. The computing device of claim 54, wherein said assigned button modification comprises:
sensing an absolute position change of a sensed finger in a first direction;
changing said button assignment from said initial button to a button adjacent to said initial button in said first direction; and
modifying said visual feedback signal according to said changed button assignment.

59. The computing device of claim 42, wherein said finger touch sensing surface comprises a plurality of touch type zones.

60. A method for providing visual feedback comprising:
sensing a touch of a touch sensing surface;
transmitting a signal corresponding to an absolute position said touch sensing surface was touched; and
graphically representing said absolute position on a display device.

61. The method of claim 60, further comprising:
simultaneously sensing a plurality of touches on said touch sensing surface; and
graphically corresponding to an absolute position of each of said plurality of touches on a display device.

62. The method of claim 60, wherein said graphically representing said absolute position on a display device comprises:
generating a soft keyboard; and
highlighting a key of said soft keyboard, said key being spatially related to said absolute position of said touch.

63. The method of claim 60, wherein said graphically representing said absolute position on a display device comprises:
generating an icon on said display device;
wherein said icon is created in a spatially accurate position on said display device corresponding to an absolute position of said touch on said touch sensing surface.

64. A method for selecting a virtual button on a soft keyboard comprising:
assigning an initial button to a finger that touches a finger touch sensing surface, said assignment corresponding to an absolute position of said touch of said finger touch sensing surface; and
modifying said assigned button in response to a movement of said finger.

65. The method of claim 64, wherein said step of assigning an initial button to a finger comprises assigning a plurality of reference keys to a plurality of initial finger placements.

66. The method of claim 65, wherein said plurality of reference keys comprise an “A,” an “S,” a “D,” an “F,” a “J,” a “K,” an “L,” and a “;” key.

67. The method of claim 56, further comprising arranging a remaining set of keys on a traditional keyboard in a spatial relationship to said plurality of reference keys.

68. The method of claim 66, wherein said plurality of reference keys are assigned in a non-linear configuration.

69. The method of claim 64, wherein said step of modifying said assigned button comprises:
sensing an absolute position change of a sensed finger in a first direction; and
changing said button assignment from said initial button to a virtual button adjacent to said initial button in said first direction.

70. A method for touch typing with a finger touch sensing input device comprising:
assigning a reference key to each of a plurality of sensed finger touches, said reference keys including one or more of an “A,” an “S” a “D,” an “F,” a “J,” a “K,” an “L,” and a “;” key;
positionally assigning additional keys on said finger touch sensing input device in spatially relation to said reference keys;
displaying a soft keyboard on a display device; and
highlighting said assigned reference keys.

71. The method of claim 70, further comprising identifying fingers associated with said sensed finger touches.

72. The method of claim 71, wherein said step of identifying said fingers comprises:
scanning said finger touch sensing input device from a middle position of said finger touch sensing device;
assigning a first sensed finger to either side of said middle position as an index finger;
assigning a second sensed finger on either side of said middle position as a middle finger;
assigning a third sensed finger on either side of said middle position as a ring finger; and
assigning a fourth sensed finger on either side of said middle position as a pinky finger.

73. The method of claim 70, wherein said plurality of sensed finger touches are in a non-linear orientation.

74. The method of claim 70, further comprising dividing said finger touch sensing device into a plurality of touch type zones, each zone being configured to sense a plurality of finger touches from a single hand.

75. The method of claim 74, further comprising independently assigning reference keys in each of said touch type zones.

76. The method of claim 70, wherein said additional keys are assigned to maximize an area of said additional keys.

77. The method of claim 70, further comprising switching to an active space mode if said positionally assigned keys have excessive overlap.

78. The method of claim 70, further comprising defining an acceptable first touch region within said finger touch sensing device.

79. A method for providing visual feedback from an input device comprising:
sensing multiple touches on a finger touch sensing device;
generating a designated icon based on a movement of said multiple touches, said icon corresponding to a function assigned to said movement.

80. The method of claim 79, wherein said icon comprises a hand icon configured to perform multiple hand gestures.

81. The method of claim 80, wherein said function comprises one of a cut function, a move function, a paste function, a copy function, Of a drop function, or a pointer function.

82. The method of claim 79, further comprising generating a plurality of designated icons, wherein each of said icons corresponds to touches from a single hand.

83. A method for providing visual feedback from an input device comprising:
sensing multiple finger contact on a finger touch sensing device;
interpreting said multiple finger contact;
correlating said finger contact interpretation with a function to be performed; and
generating a cursor in response to said correlation, wherein said cursor is a unique characteristic cursor representative of said function to be performed.

84. The method of claim 83, further comprising generating a pointer icon in response to a sensing of a single finger on said finger touch sensing device.

85. The method of claim 83, further comprising generating a pencil icon in response to a sensing of two fingers closely joined on said finger touch sensing device, wherein said pencil icon is configured to facilitate freehand drawing.

86. The method of claim 83, further comprising generating an eraser icon in response to a sensing of three fingers on said finger touch sensing device.

87. The method of claim 83, further comprising generating a ruler icon in response to a sensing of two fingers spread apart on said finger touch sensing device.

88. A data input device comprising:
a means for sensing a finger touch on a surface;
wherein said sensing means is configured to produce a visual feedback in response to a sensed touching, said visual feedback corresponding to an absolute location that said sensing means was touched by a finger.

89. The data input device of claim 88, wherein said data input device is configured to provide a function of one of a mouse, a keyboard, a stylus, or a touch screen.

90. The data input device of claim 88, wherein said means for sensing a finger touch on a surface comprises one of a virtual switch device, a touch pad, an air gap virtual switch, a rubber feet virtual switch, a peripheral switch, or a touch strength detector.

91. A computing device comprising:
a means for processing data;
a means for displaying communicatively coupled to said means for processing data; and
a means for inputting data communicatively coupled to said means for processing data, wherein said means for inputting data includes a means for sensing a finger touch on a surface, wherein said means for sensing a finger touch on a surface is configured to produce a visual feedback signal in response to a touching of said means for sensing a finger touch on a surface, said visual feedback signal being configured to cause said processing means to graphically display a visual feedback on said display means corresponding to an absolute location that said sensing means was touched by a finger.

92. The computing device of claim 91, wherein said computing device comprises one of a cell phone, a PDA, a keyboard, a palm PC, tablet PC, a PC, a watch, a thumb keyboard, a laptop, a camera, a video recorder, a web slate, an e-Book, a GPS device, a video game, a remote control, an audio/video remote control, a multimedia asset player (MP3, video), or a Kiosk terminal.

93. A processor readable medium having instructions thereon for:
sensing a touch of a touch sensing surface;
transmitting a signal corresponding to an absolute position said touch sensing surface was touched; and
graphically representing said absolute position on a display device.

94. The processor readable medium of claim 93, further comprising instructions for:
simultaneously sensing a plurality of touches on said touch sensing surface; and
graphically representing an absolute position of each of said plurality of touches on a display device.

95. The processor readable medium of claim 93, further comprising instructions thereon for:
generating a soft keyboard; and
highlighting a key of said soft keyboard, said key being spatially related to said absolute position of said touch.

96. The processor readable medium of claim 93, further comprising instructions thereon for:
generating an icon on said display device;
wherein said icon is created in a spatially accurate position on said display device corresponding to an absolute position of said touch on said touch sensing surface.

97. A data input device comprising:
a finger touch sensing surface;
wherein said finger touch sensing surface is configured to produce a visual feedback directly on said finger touch sensing surface in response to a touching of said touch sensing surface, said visual feedback indicating an absolute location that said finger touch sensing surface was touched by a finger; and
wherein said visual feedback includes a cursor visibly positioned near said absolute location.

98. The data input device of claim 97, wherein said data input device is configured to provide a function of a traditional input device.

99. The data input device of claim 98, wherein said function of a traditional input device includes a functionality of one of a mouse, a keyboard, a stylus, or a touch screen.

100. The data input device of claim 97, wherein said finger touch sensing surface comprises one of a virtual switch device, a touch pad, an air gap virtual switch, a rubber feet virtual switch, a peripheral switch, or a touch strength detector configured to actuate a selection of said visual feedback.

101. The data input device of claim 97, wherein said data input device is configured to form a part of one of a phone, a watch, a personal computer (PC), a tablet PC, a palm PC, a thumb keyboard, a laptop, a digital camera, a camcorder, a personal digital assistant (PDA), a web slate, an e-Book, a global positioning system (GPS) device, a video game, a remote control, an audio/video remote control, a multimedia asset player (MP3, video), or a Kiosk terminal.

102. The data input device of claim 97, wherein said visual feedback further comprises a highlighting of a virtual key on a virtual keyboard when said cursor is placed above said virtual key.

103. The data input device of claim 102, wherein said cursor is further configured to perform traditional mouse functions;
said functions including a cursor function, an insert function, a point function, a drag function, and a select function.

104. The data input device of claim 102, wherein a selection of said highlighted key on said virtual keyboard is generated by a cessation of said touching while said key is highlighted.

105. A method for interacting with a computing device including a touch sensitive screen display and a cursor, comprising:
receiving user finger position information from said touch sensitive screen display;
determining a cursor position based on said finger position information; and
visibly displaying a cursor close to said finger position.

106. The method of claim 105, further comprising:
highlighting a virtual key of a virtual keyboard when said cursor is placed above said virtual key; and
selecting said highlighted key wherein said touch sensitive screen display comprises one of a virtual switch device, a touch pad, an air gap virtual switch, a rubber feet virtual switch, a peripheral switch, or a touch strength detector.

107. The method of claim 105, further comprising:
highlighting a virtual key of a virtual keyboard when said cursor is placed above said virtual key; and
selecting said highlighted key when a finger generating said finger position is removed from said touch sensitive screen display while said virtual key is highlighted.

108. The method of claim 107, wherein said virtual keyboard is displayed on said touch sensitive screen display.

109. A method for modifying a cursor position message generated by a computer system operating system in response to finger position information sensed by a touch sensitive screen display, comprising:
generating an X and a Y position coordinate associated with a finger contact point on said touch sensitive screen sensor;
intercepting a cursor position message generated by said operating system;
modifying said cursor position message to be a function of said X and Y position coordinates; and
transmitting said modified cursor position message to an application hosted by said operating system.

110. The method of claim 109, further comprising:
displaying a cursor icon on said touch sensitive screen display in response to said modified cursor position message;
wherein said cursor icon is visibly positioned near said finger contact point.

111. The method of claim 109, wherein said cursor is configured to perform traditional mouse functions;
said functions including a cursor function, an insert function, a point function, a drag function, and a select function.

112. A computing device, comprising:
a touch screen including a graphical user interface (GUI) and a mouse cursor interface;
wherein a cursor generated on said touch screen is configured to be visually seen around a finger touching said touch screen.

113. The computing device of claim 112, wherein said cursor is configured to be visibly positioned near an absolute location of said finger touching said touch screen.

114. The computing device of claim 112, wherein said cursor is configured to perform traditional mouse functions;
said functions including a cursor function, an insert function, a point function, a drag function, and a select function.

115. A method for selecting an object from a plurality of selectable objects generated on a display device comprising:
receiving an position coordinate associated with a finger touch zone;
receiving positions of said selectable objects with respect to an active area zone;
correlating said position coordinate with the positions of said selectable objects; and
associating said position coordinate to at least one of said selectable objects.

116. The method of claim 115, wherein said display device is associated with a computing device;
said computing device including one of a phone, a watch, a personal computer (PC), a tablet PC, a palm PC, a thumb keyboard, a laptop, a digital camera, a camcorder, a web slate, an e-book, a video game, a remote control, an audio/video remote control, a multimedia asset player (MP3, video), or a personal digital assistant (PDA).

117. The method of claim 116, wherein said position coordinate is provided by a touch sensing surface device coupled to said computing device, wherein said finger touch zone is a portion of said touch sensing surface.

118. The method of claim 117, wherein said position coordinate comprises an absolute coordinate of a finger position detector communicatively coupled to said computing device.

119. The method of claim 117, wherein said position coordinate comprises an absolute coordinate of said finger tough zone on said touch sensing surface.

120. A method for interacting with a graphical user interface generated on a display device comprising:
displaying a plurality of selectable objects in an active area zone;
receiving at least one finger position coordinate with respect to a finger touch zone of a user input device;
determining a virtual object to be selected based on a correlation of said finger position coordinate on the finger touch zone and selectable object positions in said active area zone; and
displaying a visual feedback indicating a selected object.

121. The method of claim 120, wherein said display device is associated with a computing device;
said computing device including one of a phone, a watch, a personal computer (PC), a tablet PC, a palm PC, a thumb keyboard, a laptop, a digital camera, a camcorder, a web slate, an e-book, a video game, a remote control, an audio/video remote control, a multimedia asset player (MP3, video), or a personal digital assistant (PDA).

122. The method of claim 121, wherein said finger position coordinate is provided by a touch sensing surface device coupled to said computing device, said finger touch zone forming a portion of said touch sensing surface.

123. The method of claim 122, wherein said finger position coordinate comprises an absolute coordinate of a finger contacting a position detector;
wherein said position detector is communicatively coupled to said computing device.

124. The method of claim 123, wherein said finger position coordinate comprises an absolute coordinate of said finger tough zone on said touch sensing surface.

125. A computing device comprising:
a display screen configured to display a plurality of selectable graphical user interface objects in an active area zone;
a user input device configured to recognize at least one finger position of a user of said computing device with respect to a finger touch zone; and
a processor operatively coupled to said display screen and to said user input device, said processor being configured to determine a correlation between said selectable graphical user interface objects in the active area zone and said finger position in the finger touch zone;
wherein said display screen is further configured to produce a visual feedback illustrating a selection of at least one of said selectable graphical user interface objects in response to a finger position detected in said finger touch zone.

126. The computing device of claim 125, wherein said computing device comprises one of a phone, a watch, a personal computer (PC), a tablet PC, a palm PC, a thumb keyboard, a laptop, a digital camera, a camcorder, a web slate, an e-book, a video game, a remote control, an audio/video remote control, a multimedia asset player (MP3, video), or a personal digital assistant (PDA).

127. The method of claim 126, wherein said finger touch zone comprises a touch sensor forming a portion of said touch sensing surface.

128. A processor readable medium having instructions thereon, which, when accessed by a processor, cause said processor to:
receive a position of a finger with respect to a finger touch zone associated with a user input device;
receive positions associated selectable graphic objects on a graphical user interface with respect to an active area zone;
correlate the finger position in the finger touch zone to the positions of the selectable graphic objects on a graphical user interface in active area zone; and
determine at least one selectable graphic object to be activated based on said correlation.

129. A computing device, comprising:
a screen display configured to provide a graphical feedback; and
a position touch sensing device configured to provide interaction with said screen display, wherein said position touch sensing device is configured to sense a finger position on said position touch sensing device and to correlate said sensed position with at least one position on said screen display.

130. The computing device of claim 129, wherein said computing device comprises one of a phone, a watch, a personal computer (PC), a tablet PC, a palm PC, a thumb keyboard, a laptop, a digital camera, a camcorder, a web slate, an e-book, a video game, a remote control, an audio/video remote control, a multimedia asset player (MP3, video), or a personal digital assistant (PDA).

131. The computing device of claim 130, wherein said finger position is an absolute coordinate of a finger position detector communicatively coupled to said computing device.

132. The method of claim 129, wherein said position touch sensing device comprises a touch screen, or a touch pad.

133. The method of claim 129, wherein said at least one position on said screen display is associated with a selectable graphic object displayed on said screen display.
